(19) United States
(12) Patent Application Publication
(10) Pub. No.: US 2023/0390670 A1
(43) Pub. Date: Dec. 7, 2023

(54) ROTODYNAMIC DEGASSING PUMPING UNIT AND ROTOR BEARING DESIGN

(71) Applicant: Enersul Inc, Calgary (CA)

(72) Inventors: Damien Patrick McFadyen, Calgary (CA); Ioana Todea, Calgary (CA); Paul Roy Larson, Calgary (CA); David Alexander Shaw, Calgary (CA)

(21) Appl. No.: 18/034,482

(22) PCT Filed: Nov. 12, 2021
(86) PCT No.: PCT/CA2021/051613

§ 371 Date: Apr. 28, 2023

Related U.S. Application Data
(60) Provisional application No. 63/209,490, filed on Jun. 11, 2021.
(60) Provisional application No. 63/113,492, filed on Nov. 13, 2020.

(51) Int. Cl. B01D 19/00; B01F 27/1144; F04D 13/12; F04D 29/18

(52) U.S. Cl. CPC B01D 19/0094; B01D 19/0005; B01F 27/1144; F04D 13/12; F04D 29/18

(57) ABSTRACT

The present invention is concerned with degassing processes, and more specifically with a degassing apparatus and method for removing hydrogen sulfide and hydrogen polysulfides from liquid sulfur in a rapid and efficient manner to result in low residual hydrogen sulfide and hydrogen polysulfide levels. Utilizing a rotodynamic degassing pumping unit, a first fluid, typically in the liquid phase, is pumped or drawn under pressure or vacuum, while a second fluid, typically in a gaseous phase, is pumped or drawn under pressure or vacuum into the first fluid, effecting a chemical reaction. A rotary impeller having a plurality of blades is presented at a submerged location in the liquid sulfur surrounded by a draft-tube. The rotor (impeller) is divided into three distinct blade sections: a) a radial flow section; b) a mixed flow section; and c) an axial flow section. An overflow weir controls the depth of the liquid inside the degasser's housing. The overflow weir includes a corrugated type cross-section, comprising segments split longitudinally and welded lengthwise. The “wavy” or sinusoidal cross-sectional shape or trapezoidal or triangular shape (extending radially inwards) increases the length of the weir, which in turn minimizes the head required, and maximizes the capacity. A novel rotor bearing design is introduced as a means to mitigate excessive deflection of the main shaft. The design removes one of the two rotor bearings of the prior art and places two immersed bearings down the shaft.

### BACKGROUND OF THE INVENTION

### 1. Field of the Invention

The present invention is directed to a degassing system, a rotodynamic degassing pumping apparatus, and the processing of fluids therein. Specifically, the invention relates to a rotodynamic degassing pumping unit having a rotor (impeller) and casing design to facilitate entrainment of bubbles in a liquid, and a housing design to facilitate disengagement of gas from a liquid and a method for processing fluids having a mixture of various components and phases. The degassing unit typically includes an entrained or injected fluid (gas or air) and a pumped fluid or liquid, and may include a dissolved fluid or gas, acids and/or solids. The invention further relates to an apparatus and method for the removal of hydrogen sulfide and hydrogen polysulfides from liquid sulfur in a degassing application in a rapid and efficient manner. As a way to achieve this result, the invention includes additional novel designs, such as a new rotor bearing design to address undue deflection of the main shaft.

The invention may be useful for the production of sweet elemental sulfur from sulfur mixtures including dissolved hydrogen sulfide. Liquid sulfur degassing can be useful for controlling oil and gas industry plant stack emissions, sulfur plant stack emissions, sulfur pit vent stack emissions, and can be useful for producing a saleable elemental sulfur product. It may also be useful for the recovery of hydrogen sulfide from sulfur. There also various system options for the outlet gas. For example, the system's gas outlet may be sent to the front of a Sulfur Recovery Unit (SRU), to a Tail Gas Treating Unit (TGTU), to a Sulfuric Acid Plant (SAP), or to a hydrogen plant, or the outlet gas may be sent to an incinerator, or a Flue Gas Desulfurization process may be added to the flare gas, or the gas may be exhausted to the atmosphere.

### 2. Description of Related Art

The degassing process has useful application in the chemical, petrochemical, environmental, water and waste-water treatment and biological arenas. Air agitated mixing tanks are well known, for example it was reported in 1993 that a Union Carbide mill at Gas Hills used a flow sheet, which incorporated an air agitated mixing tank for the extraction of uranium in the nuclear industry. Some undesired gases, such as oxygen, hydrogen, or toxic gases, are expected to be removed from water, melting metal, or other liquids. A gas may be removed from a liquid. Conversely, a mass from a gas mixture may be transferred to the liquid. Removal of hydrogen sulfide from liquid sulfur is an important application of degassing.

Hydrogen sulfide is used for the production of sulfur and water, and is a raw material for the production of green hydrogen fuel and sulfur. It is a product which may be recovered during the production of natural gas, refining operations, or as a byproduct of a number of industrial operations. Hydrogen sulfide is to some degree soluble in liquid sulfur. Dissolved hydrogen sulfide may react with sulfur diradical chain species to form hydrogen polysulfides.

Hydrogen sulfide and hydrogen polysulfides slowly reach equilibrium in liquid sulfur, which can be substantially influenced by temperature. Over time, the hydrogen sulfide diffuses out of the liquid sulfur. However, under ambient conditions, this process can take weeks for the hydrogen polysulfides to decompose to sulfur and hydrogen sulfide. Moreover, the release of these hydrogen sulfide emissions may create a variety of nuisance, environmental, and safety concerns.

As reported by the United States Department of Energy, sulfur recovery processes have been known since the 1880s, chemical solvents used for commercial sulfur treatment since the 1920s, and physical solvents since the 1950s. Over the years, many systems have been designed to remove hydrogen sulfide (H₂S) and hydrogen polysulfides (H₂Sₓ) from liquid sulfur. A degassing process has proven to be successful under certain applications. Furthermore, the degassing process has become a matter of interest with increased public awareness and government regulations dealing with fugitive emissions to the atmosphere. Hydrogen sulfide has been recognized to be a toxic chemical. Essentially, the liquid sulfur needs to be degassed to below approximately 10 ppm w/w H₂S before it can be formed to a solid or transported to end users. Thus, there is a continuing need for efficient, cost-effective equipment to perform this degassing.

A simplified degassing system as it applies to liquid sulfur can be described in three basic steps: a) first, H₂Sₓ is decomposed to H₂S; b) second, H₂S is released from liquid phase to gas: and c) third, H₂S is removed from the gas space above the liquid sulfur.

In many instances, degassing systems favor the use of liquid or solid reagents or catalysts (e.g., urea, liquid amines) to effect removal, while others use air or gas, and agitation of the liquid sulfur to promote the release of hydrogen sulfide. In the sulfur industry, air degassing systems use large pits, tanks or vessels to hold liquid sulfur and sprage air or an inert gas through the liquid sulfur to provide circulation and a carrier gas to remove the hydrogen sulfide. Air is more effective than an inert gas such as nitrogen, as SO₂ can be produced by oxidization of either H₂S or H₂Sₓ; however, use of the air-degassing method to less than 5 ppm w/w H₂S in sulfur can produce a product with excessive SO₂. If air degassing is designed for degassing below 5 ppm w/w, then additional sulfur emissions occur due to increased liquid sulfur oxidation and sulfur gas losses, and since water is also produced, the corrosion by the outlet gases becomes a consideration.

The air degassing method is at least 10-times slower than amine degassing with an air sparge. Basic soluble amine catalysts (and solid catalysts) decompose H₂Sₓ by proton abstraction, which leads to unzipping of this polymeric molecule. The reaction sites can catalyze both polysulphide formation as well as decomposition, so a sparge gas is necessary to remove H₂S from the liquid. The sparge gas may be an inert gas, dry nitrogen, or CO₂.

Experiments using a sparge gas containing H₂S, such as Claus tail gas, show tail gas may be an effective sparge gas despite it containing H₂S. If the surface contact area and the gas flow rate is sufficient, the polysulphide decomposition reaction can dominate over the formation reaction, and Claus tail gas can be as effective as 100% nitrogen. No degassing will occur with 100% H₂S but degassing to less than 5 ppm w/w has been observed with ˜1.2% H₂S, 0.60% SO₂, 30% H₂O and balance in N₂. Empirical results have shown that approximately 60% conversion of the H₂S and SO₂ in the tail gas sparge was converted to sulfur product. Use of a H₂S containing sparge gas may increase yield, and may decrease energy and air consumption.

The solid-catalyst degassing may be done as the sulfur liquifies within a Claus condenser. Alternatively, it may now also be done using an auto-industry style catalytic monolith within the sulfur recovery process. The monolith's open area and the passageway size and length can be varied to accommodate desired pressure drop. Cordierite or mullite-based monoliths are options, such as an alumina wash-coated cordierite monolith.

TiO₂-based catalysts are much less susceptible than alumina to ageing and remain virtually unaffected by sulphation.

It is advantageous to accelerate the release of dissolved H₂S to the gas phase. Agitations are widely used in degassing industries because bubbles can be generated to increase the gas-liquid contact area. Various bubble generating schemes improve the desired release.

Spraying liquid sulfur is very effective for vaporizing H₂S; however, the condensing and solidification of the sulfur is sometimes overlooked in designs, and when it is ultimately considered, the sulfur load on the Sulfur Recovery Unit (SRU), Tail Gas Treatment Unit (TGTU), or the incinerator, is generally excessive and unwanted.

Hydrogen sulfide in natural gas is the main source of sulfur in Canada. In many industrial applications, H₂S is recovered by the Claus process. This process is a chemical reaction in which hydrogen sulfide is fed to a furnace, passed through a condenser-converter series, and transformed into liquid sulfur and water.

When H₂S concentration in sulfur is over a certain level it will affect sulfur quality and may cause safety problems. For these reasons, in order to purify the sulfur better, the H₂S should be degassed, preferably below 10 ppm or lower to be considered a safe level.

FIG. 1 depicts the features of a generalized H₂S-Sulfur degassing system, which may be characterized by three process steps. First, H₂Sₓ is decomposed to H₂S. The chemical reaction shows the dissolved H₂S with sulfur chains of variable lengths to get hydrogen polysulfide as a formula of H₂Sₓ:

H₂Sₓ⇔H₂S+S₍ₓ₋₁₎

Because H₂Sₓ in liquid sulfur cannot release to the gas phase directly, the H₂Sₓ must be chemically changed into H₂S and then released to the gas phase. Normally, this process is extremely slow; however, by using a catalyst such as an amine, the decomposition turns much faster.

The second step is the release of H₂S from the liquid phase to the gas phase. Henry's law explains this release process:

p=kC
where
p is the partial pressure of the solute above the solution;
k is the Henry's law constant; and
C is the concentration of the solute in the solution.

The dissolved H₂S will leave the liquid and pass into the air bubbles until balance is achieved. All the air bubbles with absorbed H₂S float up to the head space. Introducing gas bubbles or spraying liquid sulfur droplets can achieve a better mass-transfer effect.

The last step is sweeping the gas out of the head space. Air is usually used as a sweep gas to remove the H₂S in the head space of liquid sulfur. A vacuum condition is beneficial for this sweeping action.

U.S. Pat. No. 4,612,020 issued to Fischer, et al., on Sep. 16, 1986 titled “METHOD OF DEGASIFYING LIQUID SULFUR WHICH CONTAINS HYDROGEN SULFIDE,” describes a system where liquid sulfur is sprayed into two or more chambers, which are joined in series, and the liberated hydrogen sulfide is scavenged from the head space by an inert gas, such as nitrogen.

Searches of the prior art have revealed several patents related to the removal of hydrogen sulfide from liquid sulfur, and the use of various catalyst materials in such processes. Such prior art processes can be found in the following references: U.S. Pat. Nos. 3,364,655; 3,447,903; 3,807,141; 4,131,439; 4,755,372; 4,844,720; 4,849,204; 5,030,438; 5,080,695; G.B. Patent 1,067,815; and CA Patent 964,040.

Among all H₂S-S degassing technologies, the Enersul HySpec® degasser is one of the most effective. However, this unit too has disadvantages. Its production rate is limited to approximately 45 tonnes per day (tpd), whereas production rates of greater than 2,000 tpd are needed for multiple reactor systems in new sulfur plants. The Enersul HySpec® unit utilizes extremely complex mechanical and structural systems, which makes the price very high, and large agitation motors require excessive power. The tank and lid of a Enersul Hyspec® degasser unit is constructed of 300 W type carbon steel.

A problem in handling liquid sulfur is the presence of sulfuric acid that may be in some liquid sulfur mixtures, which can affect the life of the materials of construction. Sulfuric acid has a boiling point of up to approximately 337° C. that decreases with concentration, which is generally greater than the temperature of the liquid sulfur, hence it can concentrate in stationary liquid sulfurs rather than evaporate. The typical temperatures of liquid-sulfur may be in the range from approximately 130° C. to 150° C., or may be in the range from approximately 120° C. to 155° C. at the typical extremes in-service. Sulfuric acid has a density of up to approximately 1830 kg/m 3, which generally decreases with its molarity or aqueous concentration. Liquid sulfur has a density of approximately 1800 kg/m 3 more or less. As a result of the density difference, sulfuric acid may sink in the liquid sulfur, or may float on the liquid sulfur, depending on the concentration, kinetics, and flows. As a result of the boiling point difference, if sulfuric acid is present in the liquid-sulfur mixture, then it may not evaporate, or it may even concentrate in the liquid when contained in a chamber with a gas space, or it may raise to the upper surface of a relatively stationary liquid sulfur, or may sink, which can corrode carbon steels faster than desired.

Another interesting feature of elemental sulfur fluid mixtures is generally the dynamic viscosity rapidly rises to a peak at a temperature greater than approximately 185° C. as the length of the sulfur molecule chain increases.

FIG. 2A depicts the process of the Enersul HySpec® degasser 10 showing the degassing units in a series configuration for a gravity-fed process. In this design, there are four reactors 12a-d combining together to perform the degassing process. Inside each reactor, coil pipe is located in the bottom to supply heat to keep the temperature above 140° C. by using steam. Inside liquid levels are maintained by a plurality of weirs through the degassing system. The liquid levels of each degassing unit are different, insomuch as the liquid travel from one degassing unit to the next is not uniform.

Each reactor is a closed tank equipped to receive sulfur through an inlet 14a-d located generally at the bottom. A draft tube 16a-d, communicating with ducting supplying the sweep gas, is centrally located in the tank and extends below the liquid sulfur surface with a bladed impeller 18a-d. The draft-tube is perforated typically with approximately 3/8-inch diameter holes. The incoming sulfur from one degassing unit to the next is transported by gravity feed. As note, the liquid sulfur levels in each adjacent degassing unit decrease from the initial input to the final output.

The mechanical agitators run at about 780 RPM. Sweep air is fed through the draft tube and into the impeller, which also draws sulfur upward the draft tube. When agitated, gas bubbles are generated to obtain a large gas-liquid contact area. Gas bubbles and liquid pass through the perforations into a related quieting zone, where the bubbles with gaseous H₂S can separate from the liquid sulfur and float into the head space above the liquid level. The sweep air is then mixed with the H₂S gas and drawn by a blower fan.

Hydrogen sulfide degasification from sulfur is described above and used in the sulfur industry. Similarly, there are many other undesired gases, such as oxygen, hydrogen, and toxic gasses, which need to be removed from some fluids in other industries, such as metal processing, food and beverage processing, or chemical processing, all of which can benefit from a degassing process. The present invention is not strictly limited to degassing hydrogen sulfide from liquid sulfur.

In a number of applications, given the large size of degassing units (especially in configurations where a number of such units are linked in series), capacity becomes an issue at many sites. It is desirable to have a degasser system with capacity greater than 10-, 20-, or 30-times current designs that are capable of fitting within the same footprint as the current designs.

It is a further desire to have a degassing unit design that promotes air entrainment for the sparing, stripping, transport, or separation of gas from the initial liquid.

### SUMMARY OF THE INVENTION

Bearing in mind the problems and deficiencies of the prior art, it is therefore an object of the present invention to provide a degassing system from removing hydrogen sulfide (H₂S) and hydrogen polysulfides (H₂Sₓ) from liquid sulfur, wherein the degassing system includes a plurality of rotodynamic degassing pumping units configured in series and having a resulting pumping action between each unit.

It is another object of the present invention to provide a rotary impeller to a rotodynamic degassing pumping unit, the rotary impeller having a plurality of blades situated about a rotational shaft along the vertical axis, the rotational shaft in mechanical communication with a motor, and including: a mixed flow impeller section having blades in mechanical communication with the rotational shaft and responsive to the motor, the mixed flow impeller section blades providing aeration to a fluid and transfer the fluid upwards, and to facilitate a pumping action for the degassing unit.

A further object of the invention is to provide an axial flow impeller section to a rotary impeller of a rotodynamic degassing pumping unit, where the axial flow impeller section has blades forming a circular control volume defined by an outer diameter of the axial flow impeller section blades, the axial flow impeller section adjacent a mixed flow impeller section.

It is yet another object of the present invention to provide a radial flow impeller section to a rotary impeller of a rotodynamic degassing pumping unit, where the radial flow impeller section has blades in mechanical communication with a rotational shaft and responsive to a motor, and where the radial flow impeller section blades rotate at a predetermined speed to optimize fine, granular bubbles, and entrain the bubbles in fluid during rotation, and where the radial flow impeller section blades are configured to direct the fluid radially outwards from the rotary impeller.

Another object of the present invention is to provide a method for removing hydrogen sulfide and hydrogen polysulfides from liquid sulfur comprising: providing a rotodynamic degassing pumping unit having a rotary impeller having a plurality of blades at a submerged location in the liquid sulfur about a rotational shaft, including: a mixed flow impeller section having blades in mechanical communication with the rotational shaft and responsive to a motor, the mixed flow impeller section providing aeration to a fluid and transferring the fluid upwards, facilitating a pumping action for the rotodynamic degassing pumping unit; providing a draft-tube surrounding the rotary impeller, the draft-tube having a plurality of apertures; feeding a stripping gas for hydrogen sulfide to the submerged location; providing a catalyst for conversion of hydrogen polysulfides to hydrogen sulfide; rotating the rotary impeller about a vertically mounted shaft at a speed sufficient to draw liquid sulfur into the interior of the draft-tube and distribute the stripping gas, forming a gas-liquid mixture; flowing the gas-liquid mixture through the draft-tube plurality of apertures; and removing the stripping gas from the liquid sulfur.

Still other objects and advantages of the invention will in part be obvious and will in part be apparent from the specification.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 depicts the features of a generalized H₂S-Sulfur degassing system, which may be characterized by three process steps;

FIG. 2A depicts the degassing units of an Enersul HySpec® degasser, showing the units connected in series for a gravity-fed operation;

FIG. 2B depicts the rotodynamic degassing pumps of the present invention, showing the units connected in series, and maintaining approximately equal liquid levels in each unit;

FIG. 3A depicts the mixed and axial flow sections of the impeller of one embodiment the present invention;

FIG. 3B depicts the mixed and axial flow sections of the impeller of another embodiment the present invention;

FIG. 4A depicts a detailed view of an embodiment of the blade portions for the mixed and axial flow sections of the impeller;

FIG. 4B depicts a detailed view of the blade portions for the mixed and axial flow sections of the impeller of a second embodiment of the present invention. Mixed and axial flow sections are spaced apart;

FIG. 4C depicts a detailed view of the blade portions for the radial, mixed, and axial flow sections of an embodiment of the impeller design;

FIG. 5A depicts a detailed cross-sectional view of the mixed and axial flow sections of the impeller portion of FIG. 4A;

FIG. 5B depicts a detailed cross-sectional view of the mixed and axial flow sections of the impeller portion of FIG. 4B;

FIGS. 6A and 6B depict the location of the leading and tailing edges of an axial flow impeller (FIG. 6A) and mixed flow impeller (FIG. 6B);

FIGS. 6C and 6D represent cross-sectional views of the impeller tips of FIGS. 6A & 6B respectively, depicting the leading edge and the tailing edge;

FIG. 7 depicts a schematic of an embodiment of the degasser impeller design and the directional flow of the fluid and bubbles entrained therein;

FIG. 8 is a schematic of the fluid flow about the radial flow impeller blades. A growing turbulent boundary layer is generated when the shaft is rotated at a predetermined rotational speed;

FIG. 9A depicts an embodiment for the overflow weir of the present invention; and

FIG. 9B depicts a partial cross-sectional view of the trapezoidal shaped labyrinth of the overflow weir.

FIG. 10 depicts a partial exploded view of a single roller bearing centered about the shaft;

FIG. 11 depicts a cross-sectional, partial view of the upper rotor (impeller) design. One set of roller bearings 35 is shown;

FIG. 12 depicts the placement of the immersion bearings 50, 52 further down shaft 1;

FIG. 13 depicts a cross-sectional schematic of the impeller/bearing design with immersion bearings 50, 52 placed about the impeller shaft, and the directional fluid flow of liquid sulfur through each immersed bearing;

FIG. 14 depicts a cross-sectional view of an immersion (sleeve-type) bearing, showing the shaft surrounded by a sleeve and sulfur bearing bush or bushing 76;

FIG. 15 depicts a partial cross-sectional view of an immersion bearing of FIG. 14 showing the proximate relationship between sulfur bearing bush or bushing, sulfur bearing sleeve, outer round bar, and wearing ring;

FIG. 16 is a cross-sectional view of the impeller design looking vertically down the shaft axial center. Axial grooves 100 can be seen formed in the bearing bush;

FIG. 17 depicts the flow of the liquid sulfur through axial grooves, radial grooves, or a combination of both; and

FIGS. 18A-D depict the radial grooves proximate the main shaft at various locations including proximate the main shaft nut.

### DESCRIPTION OF THE PREFERRED EMBODIMENT(S)

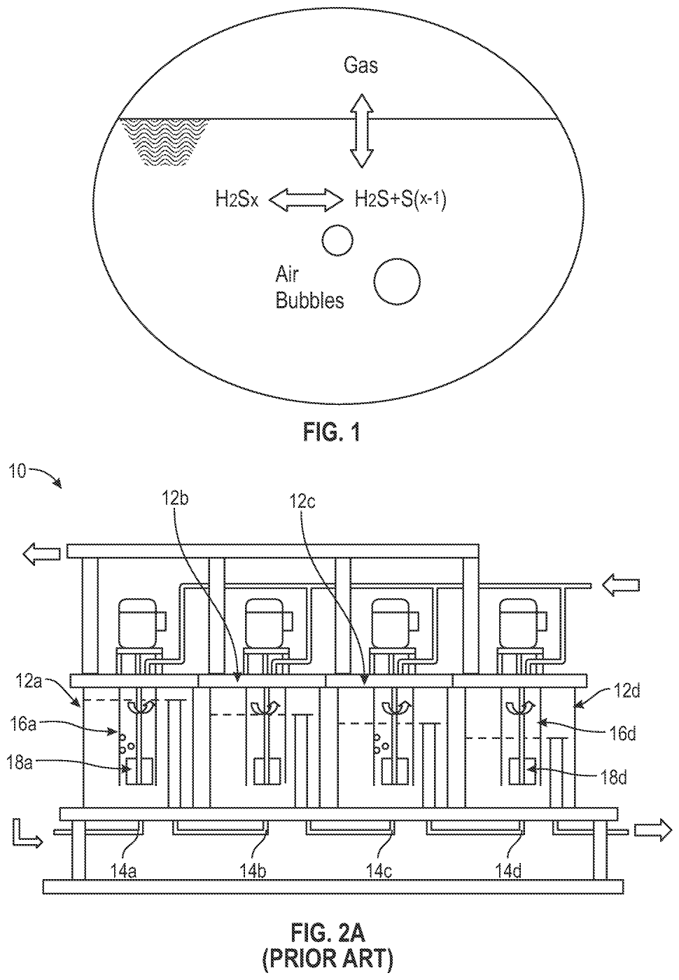

In describing the preferred embodiment of the present invention, reference will be made herein to FIGS. 1-18 of the drawings in which like numerals refer to like features of the invention.

The present invention is generally concerned with degassing units, and more specifically with an apparatus and method for separating hydrogen sulfide and hydrogen polysulfides from liquid sulfur in a rapid and efficient manner to result in low residual hydrogen sulfide and hydrogen polysulfide levels. It produces elemental sulfur and hydrogen sulfide.

Generally, bubble coalescence should be avoided, as decreases the effective surface area of the gas-liquid contact. Aside from the removal of H₂S from liquid sulfur, the degasser may also be used to contact or react gas or air bubbles with other liquids such as water. A surfactant may be added to help maintain air or gas bubbles in water and other liquids, so long as bubbles do not create excessive foam. For example, a molecule including a water-loving hydrophilic head and a water-hating hydrophobic tail could be added to separate a gas bubble's surface from water at the molecule-level. Additionally, gas or air may be injected to generate bubbles, such as a swirl liquid flow type bubble generator, a venturi-type bubble generator or an ejector-type bubble generator.

### Degassing System

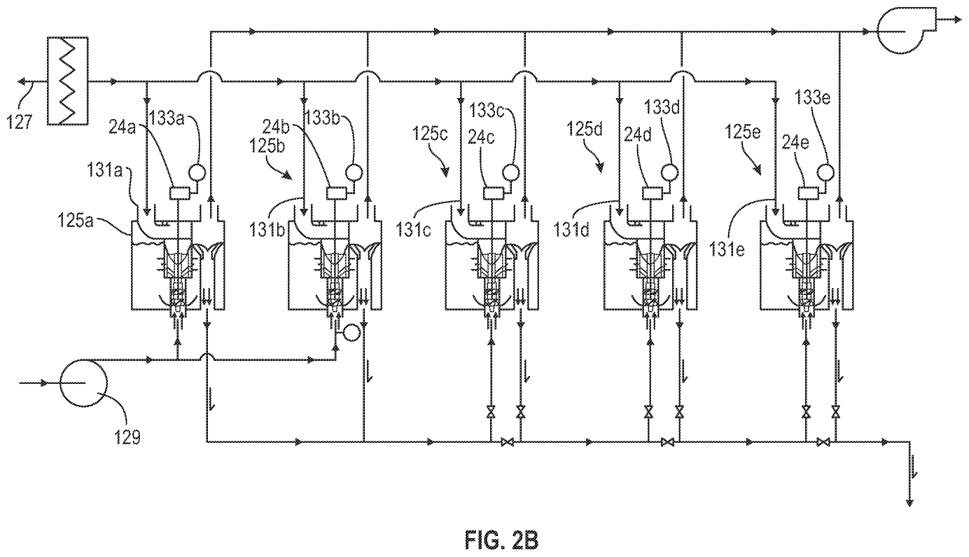

A degasser may be a single reactor unit or a degassing system including multiple reactors. The actual configuration of the degasser system depends on the actual application, the actual gas feed and the actual liquid sulfur feed and actual reduction in concentrations required. FIG. 2B depicts the rotodynamic degassing pumps 125a-e of the present invention, showing the units connected in series, and maintaining approximately equal liquid levels in each unit. Ambient air is typically used for the air inlet supply 127; however, another gas or mixture of gases can be used. Air can be the preferred sparge gas or stripper gas, as it contains mainly nitrogen. Soluble amine and solid catalysts decompose H₂Sₓ by proton abstraction, and stripper gas is still required to remove the resulting hydrogen-sulfide from the liquid. Since oxygen is not required for the polysulfide decomposition using either amines or solids, use of an inert gas such as nitrogen, or air that is a mixture including mostly nitrogen, would prevent sulfur-dioxide or decrease sulfur-dioxide formation. In at least one embodiment of a degassing process of the present invention, a first fluid 129, typically in the liquid phase, is pumped or drawn under pressure or vacuum, while a second fluid, typically in a gaseous phase, is pumped or drawn under pressure or vacuum into the first fluid, effecting a chemical reaction. Unlike the gravity-fed series configuration of the prior art, the preferred embodiment encompasses a series configuration that is governed by liquid transfer via negative pressure (near vacuum), where liquid is drawn from one degassing unit to the next. In this manner, the capacity of each unit may be approximately equivalent, which in turn increases the capacity of the entire system.

Stripping gas targeting hydrogen sulfide (or other undesirable element) is generally drawn into a submerged location in the liquid sulfur within the draft-tube, casing, or intake. An oxidizing gas may be employed as the stripping gas. The gas may be nitrogen or a carrier gas to create bubbles or voids within the liquid, to receive a gas from the liquid to the receiving bubbles' or voids' space. The stripping gas may include steam, and is designed to remove hydrogen sulfide within the liquid sulfur from the reaction vessel. An amine catalyst is typically utilized in conjunction with the steam, however in this invention it is not recommended to use steam, as the sulfur tends to solidify or the unit equipment of the process tends to make it impractical to construct or operate cost effectively. Alternatively, steam may be added or required, but is typically not a preferred usual design. An amine that is a gas or a volatile liquid, which does not form salts that buildup in piping, as result of reaction with liquid sulfur, may be used. When an oxidizing gas is used as the stripping gas, the oxidizing gas may be oxygen or sulfur dioxide, generally transported in an inert carrier gas, such as carbon dioxide or nitrogen.

In an illustrative embodiment, the first fluid is typically liquid elemental sulfur including a hydrogen sulfide gas and a degassing catalyst. Alternatively, the liquid being processed may be water or wastewater with at best only traceable amounts of hydrogen sulfide, and no catalyst. The first liquid may include entrained gas or air, and may include dissolved gas. Furthermore, solids may be introduced as well. The fluids may be a mixture of various components and phases, and will typically be Newtonian fluids for degassing application. Alternatively, non-Newtonian fluids may be introduced if the methods or components are applied to degassing during sulfur melting or wastewater treatment.

When sulfur is the liquid, the liquid flow rate through unit must be sufficient to avoid sulfur solidifying during use in the actual ambient temperature at site. Alternatively, thermal insulation or heating may be added to the unit.

In an embodiment of a degassing system of the present invention, a gas or volatile liquid catalyst is used. Various catalysts and various families of catalysts and blends are available for sulfur degassing. It is well known the more catalyst that is added, the more active the degassing, but it is not obvious that catalyst removal is more difficult than H₂S removal. A catalyst must be disengaged from the output product or removed prior to the liquid sulfur product exiting a degassing system to sufficiently low values for downstream purpose. In the present example, most of the degassing is completed within the first one or two stages of a degassing system, and may occur during more stages or all stages. The catalyst's concentration in the liquid sulfur may progressively decrease through the system, particularly during processing within the last units of a system, which may be adjusted for appropriate catalyst disengagement or gaseous catalyst removal prior to product exit. Preferably, the catalyst liquid's boiling point must be less than sulfur temperature or the catalyst will not boil, and will tend to remain in the liquid mixture and will exit in the system with the liquid sulfur product.

A volatile liquid catalyst, such as an amine, may be injected onto the liquid upstream of the system or upstream of the first or second or H₂S removal stage reactors, or may be injected as a gas in the air or gas inlet of those units 131a-e. The catalyst must have a boiling point that is below that of sulfur's boiling point for the gas to be removed or disengaged from the liquid sulfur in the applicable degasser units that may be multipurpose. The system design, unit design, as well as the adjustment and the disengagement, ensures the catalyst is not in the output liquid sulfur, or at a very low concentration that may be unmeasurable.

The creation of a central vortex draws air into the liquid because the pressure towards the center of the depression is less than atmospheric pressure as the rotor spins. It has been found that a way to evaporate and disengage the volatile-amine is to decrease the concentration of the catalyst in the sulfur to less than desired value before the liquid sulfur exits the last unit of a degasser system.

The central vortex must be developed to enable air or gas flow through the unit, which effectively draws ambient air or a gas into the unit at the center of the vortex that has surface air-liquid interface at below atmospheric pressure. The depth of the central vortex should not exceed the depth of the highest sulfur bearing that should be fully immersed. The upward rising jet from the tailpipe nozzle has effect on the downwards depth of the vortex, and there exists an upwards jet velocity and head height that balances the downwards low-pressure depression of the central vortex. The depression is a function of the radial flow, which can be correlated to the impeller's diameter, speed, and depth. The jet height is a function of the axial flow impeller's diameter and blade-pitch, the tailpipe's stator vane angle (that may be set to allow the jet to swirl), the tailpipe's nozzle diameter, and the pump's rotor speed and flow rate. The tail pipe's nozzle directs the flow to the hub of the radial flow impeller.

It is not known in the art to utilize a stator in a degassing unit. A stator can hold the bearing, correct the mixed-flow impeller, and the axial-flow impeller's swirl, change direction of the fluid, and/or shear the fluid. Additionally, as discussed further herein, the utilization of a nozzle in the degassing unit to direct liquid flow upwards and entrain adjacent fluid, while sending fluid to the depressed eye of the central vortex, helps keep the upper bearings immersed. Alternatively, or additionally, gas or air may be injected to generate bubbles, such as a swirl liquid flow type bubble generator, a venturi-type bubble generator or an ejector-type bubble generator.

During system startup, the reactors are first primed. Starting the rotor may cause an initial spike in the exhaust air H₂S concentration. The spike may be avoided by adding steam or air into the exhaust-air gas space during starting, to reduce the H₂S concentration at air outlet during starting. Alternately, an externally pumped wet-run capability may be added to rotor's sulfur bearings to enable the sulfur bearings to function during initial priming. Alternately, a sulfur bearing bushing, sleeve, or shaft material having sufficient dry run capability may be used. The concentration of H₂S in the exhaust air outlet mixture should be less than the Lower Explosive Limit (ELE) (3.5%), which can be accomplished with suitable gas flow rates.

Improvements to various components of a degasser system are introduced in certain embodiments of the present invention as further discussed below.

The degassing unit drive system is modified to include variable frequency drives (VFD's) 133a-e to drive accompanying motors 24a-e; however, it should be noted that it is possible to configure the system so that one VFD drives a plurality of motors. Compressed air tends to be a relatively costly power source, though many successful pit degassing operations use compressed air for mixing that is shearing the fluid. Open steam systems consume boiler-water and tend to be a relatively costly power source, though steam powered vent educators are used in some successful pit degassing operations. Some degassing systems use a pump to flow, mix or overflow the fluid, or to pressurize and spray the fluid. Some degassing units including a pit, a catalyst dosing station, a cooler, pumps, and sprayers reportedly required a capital expenditure equivalent to approximately 20% of a Claus unit's cost.

The prior art designs include either fixed electric motors with a pulley or gearbox reduction to provide the required impeller speed, power, and torque, or a variable hydraulic drive. None of the designs prevalent in the prior art introduce a variable frequency drive. A VFD 133 puts more power directly to the fluid. The advantages of a variable frequency design include the capability to adjust the speed of the impeller, which in turn controls the recirculation inside the degasser unit. This adjustment controls how much fluid gets pulled into the unit. The VFD also provides for a gradual start-up of the unit, matching the available power and torque of the impeller, slowly speeding up or slowly accelerating the unit rather than an instantaneous high-speed initiation. Use of a VFD also avoids having to implement a hydraulic drive on the unit for regulating speed control. Unlike prior art designs, the motor 24 may drive the shaft of the degasser directly, which in turn would substantially reduce or eliminate costly components from the degasser's drive system. In at least one embodiment of the present invention, there can be a dedicated VFD 133 for each degassing motor, which provides for individual adjustment of each degassing unit.

In the present configuration, there are no additional motive force devices, such as ejectors, air compressors, air supply blowers, or the like, to pressurize gases into the liquid sulfur degassing or recovery system. A degassing system's water and energy use, capital expenditure, and operating expenses are reduced by the practice of certain embodiments of the present invention, for the most part through the direct application of power to shearing the fluid that requires degassing. In an illustrious example, a VFD is used with an electric motor that direct-drives the rotor that is shearing the fluid. A VFD is very efficient, for example 90% efficient for loads greater than 25% of full load and greater approaching full load are typical. Total water and energy use is further decreased by operating the applicable air, gas, and steam supply mass flows and pressures as close to ambient as practical for the actual service, to keep their temperature difference relative to ambient small, to reduce or avoid unnecessary heating of the fluids, and to reduce or avoid heat transfer to the environment during the creation, pressurization, or supply of the air, gas, or steam. Compressed inlet gas or reagent injection is an option for some configurations or service.

A known deficiency of prior art designs is attributable to the bearings, which have been found to fail before their calculated life. The degasser operates at a temperature in the range from approximately 135° C. to 145° C., which is greater than cold start condition which can be as cold as −50° C. A shaft of stainless steel material, preferably 316 SS, with a 40° C. temperature change between bearings approximately 380 mm apart will want to axially move 0.2 mm, for example. Normally one bearing should locate a shaft in one place (axially), and the other bearings on the shaft should let the shaft float or slide axially relative to the shaft. It has been shown that floating bearing races corrode or seize onto the shaft or into the bearing's housing, which may overload the now-fixed bearings, such as when the shaft changes length from thermal expansion in-service. Similarly, as the main shaft changes length, a rotary seal should accommodate the dimension change. Prior art designs have not considered or taken into account the length increase of the shaft caused by thermal expansion, or at least failed to communicate the likely actual temperature distribution in order for the drive system to adequately accommodate the increase. Furthermore, there remains a need to include a floating bearing, and overcome axial seizing potential of the bearing in a nominal elevated-temperature sulfur service.

In a separate embodiment, a toroidal bearing may be introduced that allows the bearing to float approximately a millimeter or greater internally, which is intended for use in elevated temperature service. A toroidal bearing is a self-aligning cylindrical roller bearing inside a spherical bushing, which allows the bearing to accommodate misalignment and axial growth of the shaft. The addition of a spherical ring limits the radial capacity of the bearing by reducing the diameter of the rollers that can be incorporated into the predefined design envelope (smaller rollers equating to less load capacity). In one embodiment of the present invention, a toroidal bearing was introduced into the design to let the motor end of the shaft float in service, which in turn is predicted to increase the operational life of the degasser under actual conditions.

Importantly, motor controls must not dead-head or shut-in the axial flow pump, or as a result, the drive may be overloaded or damaged. Axial flow pumps have a different pump curve as compared to centrifugal pumps and can generate much higher head a low/no flow and use a lot more power at low/no flow. It may not be possible for operators in sulfur plants to appreciate the damage that may result from running this new pump. As a precautionary measure, a VFD may be programmed to cut power if excessive current or motor power is sensed during operation.

Seals have also been implemented in the new design to protect the bearings. Packing is generally used for sealing; however, this does not represent a gas seal, and may leak or allow liquids and gases into bearings, and may leak or allow lubricant and grease to drop out of the bottom bearing. Leakage of bearing seals is also frequently a problem with liquid sulfur pumps, and screw conveyors submerged in liquid sulfur as the liquid solidifies at ambient temperature, which abrades seals and shafts faster than would be expected for a gas or liquid seal. The lubricant that is between the upper grease lip seal and the lower grease lip seal, which may be oil or grease, may serve as an ancillary seal to gas that may be present inside the degasser's housing, particularly when a unit is paused or stopped. Back-to-back lip seals may be implemented, capable of separating two different media. As to flow patterns, the lip seals are directional in nature. The upper of the back-to-back lip seals is the lower grease lip seal. The lower of the back-to-back-lip seals is the sulfur lip seal.

Protecting the lower rotary lip (sulfur) seal is one or more hydrodynamic labyrinth seals. There is a main-shaft slinger as well. The function of those parts, being part of an overall rotatory sulfur seal system, has not previously been implemented on degassers or sulfur pumps. Preventing sulfur from damaging the rotor bearings can be achieved by the implementation of the aforementioned seals.

Fluid flows in an annulus between two cylinders; the inner cylinder is generally the shaft or sleeve, which is rotating at a frequency, and may also be whirling with an amplitude or eccentricity and a frequency. The outer cylinder is generally static and fixed to the support structure. In both hydrodynamic bearings and seals, the basic fluid motion is caused by the rotation of the shaft. In a seal, there is an additional axial flow due to the imposed axial pressure difference. In a squeeze-film damper, there is no rotational motion, but forces are generated by the whirl motion of the rotor.

During service at lower liquid levels, the labyrinth seal's surface may condense sulfur gas to liquid phase that may remain liquid or may solidify, which may fill or partially fill the labyrinth or reduce the gap between the stationary and rotating parts.

Liquid sulfur is a non-Newtonian fluid. Sulfur's viscosity initially decreases as temperature increases above its approximate 115° C. melting point and then the viscosity increases dramatically, as the temperature approaches approximately 160° C. The greater viscosity of the sulfur, either immediately above the melting point or immediately before it becomes excessively high, may be used to increase the minimize film thickness of sulfur bearing. The viscosity should not be excessively high, or pumping or degassing performance may be adversely affected. The viscosity may be adjusted by adjusting the sulfur's temperature prior to inlet or within the pump including sulfur bearing and sulfur seal.

At temperatures that are greater than approximately 115° C. the sulfur will be a liquid or will melt. During continuous operation, the sulfur gas may condense, and liquid or solid may bridge the gap, rub, or melt with heat from the shear or frictional contact of the teeth or the sulfur's liquid or solid surface to create a hydrodynamic seal that is capable of resisting an axial pressure difference. During service at higher liquid levels, the labyrinth seal provides protection to the sulfur lip seal, particularly when starting, adjustment, or during other conditions when the teeth are exposed and have rotodynamic consequences, for example, when the liquid level or a jet within the housing increases vertically to the height of the rotating main-shaft slinger. The slinger is clamped around the outside of the shaft, so that it rotates with the shaft, and prevents the direct impact of a liquid jet with the labyrinth. If the height of liquid continues upwards, it enters the hydrodynamic labyrinth seal. The main-shaft or the main-shaft sleeve (the wearing surface about the shaft) rotates the fluid, which creates an axial pressure differential across the seal, which reduces the axial flowrate to restrict the flow and increase life of the sulfur lip seal that protects the grease lip seal of the roller-bearing's grease-filled housing. When the labyrinth's teeth are exposed, the axial pressure drop and the seal's mean fluid motions may be dominated by through flow over and between the teeth, depending on the actual Reynolds numbers (the actual velocities and dimensions) involved. The labyrinth may be used during starting or adjustment of a unit, or any other condition when the liquid level in the housing immerse the seal. For example, if the downstream piping is excessively restrictive or plugged, or an outlet valve is closed accidentally, or if a downstream unit of a degasser system is paused or stops or is not pumping, then the liquid level may raise higher than desired for optimum level for best degassing efficiency.

Alternatively, in units that are required to continually operate with a liquid level that continually immerses the seal area, then the shaft slinger and the labyrinth seal or seals may be replaced with a steam-filled bellows type seal, which is a style that is sometimes used to seal the main-shaft of a pressurized horizontal-shaft centrifugal sulfur pump. Alternately, a sprung mechanical type of seal may be used in place of a main-shaft slinger and the labyrinth seal, however these can be relatively expensive and unreliable. A balance gas or steam may be included. The steam-bellows type of seal and the mechanical seal options both tend to more expensive and may be less power efficient; however, they may resist greater axial pressures including pressure difference that is much greater than atmospheric pressure, if longer operation with high sustained high liquid level or continuous operation above atmospheric pressure is desired. Typically, the pressure inside the degasser's housing will be less than ambient pressure, but this may not always be the case with all designs.

The present design utilizes a single roller bearing at the motor or drive end of the shaft. To minimize wear and axial movement at the bearing near the elemental sulfur, this bearing nearest the sulfur contact is internally relegated as the axially locating bearing. The immersed bearings in the sulfur resist radial movement of the shaft, whereas the roller bearing minimizes axial movement of the rotor relative to the rotor's casing, which may prevent a close-clearance rotor from seizing inside the casing or wear sleeve when running a relatively long shaft that necessitates turning in both cold and hot conditions.

Interconnecting piping between degasser units is also modified to enhance the degasser design flow rate of the present invention. A present requirement for 2,200 tonnes per day flow rate, which is approximately twenty-eight (28) times greater than a typical degasser flow rate of the prior art (approximately 78 tons per day) will necessarily require an interconnect redesign. This is especially true when one considers the implementation of a non-gravity fed design, utilizing a negative pressure (or vacuum) draw from one degasser unit to the next. A nominal interconnection pipe size in the range of 12-inch to 14-inch would be required for gravity-fed operation between interconnected degasser units in order to accommodate the increased flow rate. This pipe size is a much greater diameter than the existing design's nominal 2 to 8-inch liquid piping, which is run between degasser units.

Within an interconnection pipe-run between units there should be no gas traps or vapor-locks along the interconnection piping that is between degasser units. The piping should smoothly exit downwards from the unit, and the piping should smoothly travel upwards to the unit. If gas is trapped in a pocket, then there must be sufficient liquid head to push design capacity liquid flow past the pocket, or pump will vapor-lock. The velocity in the piping should be sufficient to transport all particles including solids. A pump may be reconfigured for pumping solids or acids. The rotodynamic degassing pumping unit is intended for drawing, but may be reversed or reconfigured for pushing fluids. The pump is not intended to develop pressure greater than approximately 15 psi, but could be used to develop a greater pressure differential. In working conditions, the impellers are immersed in sulfur that has much larger viscosity than water. A higher fluid viscosity (or internal friction) results in a degradation in pump performance by reducing flow, head, and efficiency, and by increasing power consumption. Effectively a greater equivalent water flow rate is needed to pump sulfur at the same rate because of viscosity difference. A feature of the rotodynamic degassing pump is the pressure, head, and flow it produces, which is mostly a function of the velocity that is added to the fluid by the impeller blade.

As discussed above, a new rotodynamic degassing pumping system is introduced. An approach to use a degasser as a pump for the next degasser in serial operation is introduced. It has been shown, through use of the degasser as a multiple fluid, multiphase pump, both for internal pumping, external pumping, and pumping both air and liquid, the interconnecting pipe may be converted to a pumped-line that increases the flow capacity of the affected liquid sulfur piping, so that relatively small diameter pipe of approximately 2 to 8-inch diameter would be sufficient to transport 2,200 tons per day of liquid sulfur between units. This rate of flow is not possible with the gravity-fed degasser technology of the prior art.

A degassing (or chemical reaction) model has indicated the existing volume of liquid inside a degasser's housing was a little greater than needed for the flow rate and a required reaction or degassing rate. However, it became necessary to increase the through-flow rate to ensure the degasser properly functions, shear the fluid, confirm upsizing the weirs and the inlet, and draw liquid into the unit. One design constraint was to leave the elevation of the degassers as they currently stand in the prior art—all mounted at the same elevation. Moreover, the interconnected rotodynamic degasser pumping units were all chosen to be of similar construction, which significantly minimized manufacturing cost. Essentially, it is a design attribute of the present invention to transform the degasser into a much-improved pump for a degassing system implementing a series of degassing units.

### Rotor and Casing Design

The rotor includes a main-shaft, nose-cone, three impellers (mixed-flow, axial-flow and radial-flow), and a tail-cone. The rotor is inside a casing. The casing includes an intake, stator, tailpipe (that includes a stator too), tailpipe nozzle, a radial distributor (open-hole section) and a draft-tube. The first two impellers are basically drawing fluid that is mostly liquid, and applying pressure to the tailpipe nozzle that directs the main flow. The last impeller draws air from the top, and the impeller's tips create bubbles. Alternatively, if the topmost impeller were not totally immersed, then air could be injected at the impeller's inlet, to avoid need for central vortex to draw in air. Alternatively, having the impellers totally immersed would have the air supplied just prior to the topmost impeller, just above the stator. Injecting the air into the unit itself would remove the need to use the impellers to draw the air down.

Rotor speed may be a maximum value of ranging from 750 rpm to approximately 6050 rpm. The rotor, main shaft, and/or immersed bearing, diameter may be decreased by using higher speeds, to decrease the size or cost of a unit, or to increase a unit's pressure rating. The higher speeds may be used to decrease the diameter of the immersed bearing, increase bearing life, increase fluid's shear, increase flow rate, capacity, pressure, or suction. The limiting factor for the pump is typically the first impeller's inlet blade-tip vortex cavitation at relatively slow sulfur inlet fluid velocities. Careful smoothing of the transition from the leading edge to the tip can reduce cavitation inception.

Depending on the shape and pressure loses of the inlet, the intake duct and the impeller and stator designs, the frequencies of oscillation, the potential for unsteady flows, the potential for rotating stall, rotating cavitation, surge, or auto-oscillation, the rotor-stator interaction flow patterns and forces, the developed cavity oscillation, the acoustic resonances, the potential for blade flutter, and the potential pogo instabilities, it is found the maximum practical tip speed may be in the range from approximately 35 m/s to 45 m/s. Higher motor speeds than equivalent to 45 m/s tip-speed may require the addition of a reduction gearbox. The maximum practical direct-drive rotor speed is typically 4500 rpm to 5000 rpm. When enhanced flow is desired or more important than power efficiency, a relatively small impeller will allow higher shaft speed to better match commonly available motor speeds and power outputs. A relatively small impeller diameter may give a greater flow ability, may reduce rotor cost, may increase sulfur-bearing life.

Fluid flow that recirculates or collapses on the blade's suction surface is referred here as partial cavitation, which is different to backflow cavitation that is defined as cavitating bubbles and vortices that occur in the annular region upstream of the inlet when pump is required to operate in a loaded condition below the design flow rate. Backflow cavitation causes the flow in the vicinity of the tip vortex to have an upstream velocity component or have a potential for backflow cavitation, as the flow decreases or the pressure difference across the rotor (impeller) is increased, though this is typically a lesser concern so long as the gap from blade-tip to wear-ring or casing is not excessive. With all other conditions met, there is often a critical peripheral speed of the impeller's tip relative to the fluid's actual velocity at the impeller's blade tip.

Partial cavitation or blade cavitation on the suction side of the blade is a possibility that begins at the leading-edge of the blade, depending on design of the impeller including the blades. Partially or super cavitating cascade may occur on a set of blades of a given impeller, which may affect downstream flows and flow rate. Flat plate blades that are partially or super cavitating produce a stable coefficient of lift; however, at lift coefficients between those developed cavities, the flow is unstable. A stable non-cavitating flow or a stable cavitating flow may be desired.

In one embodiment, flat-plate blades were chosen for the degassers present configuration, as they can be operated in a stable manner, can be cost effectively produced by welding the plate to the hub, machined and dressed to required dimensions, and will generally cavitate (to some degree) to increase the total shear of the fluid, which has effect on the degassing rate. The first and the second impellers operate in a partial cavitating mode; however, their speed or pitch may be increased to operate in a super cavitating condition. The third impeller may more generally operate with super cavities. Typically, cavity or bubble collapse does not occur on a blade's surface, or it occurs downstream, so the potential for cavitation damage is minimized. Alternately, the impeller blade design, shape, area, quantity, flow, speed or pitch, may be changed to reduce cavitation or not cavitate, to increase impeller life. The blade cross-section may be curved or profiled to increase suction pressure, increase flow, or to increase (or decrease) cavitation, for a given diameter, speed and pitch, and/or to increase H₂S transfer.

Care is needed to ensure an unstable fluid-dynamic condition, or a fluid-flow's dynamic frequency resulting from the fluid flow velocity, viscosity, or density, or a solid-boundary's passage shape or dimension, or the moving blades, or the stationary vanes, does not couple with the rotor's natural frequency that is function of the rotor's mass and stiffness, or cause excessive amplitude movement that must be considered in the design. Cavitation can produce noise and vibration. Collapsing cavitation bubbles may damage some solid boundaries, such as casing, wear-rings, stators, impeller blades or hubs.

Bubble cavitation on the surface of a blade can be another factor, which may initiate from bubble nuclei being present in the inflow prior to the blades. Features within the housing minimized the carry-over of bubbles to the inlet of the unit.

The maximum shaft speed limit is a function of shaft power, impeller diameter, blade pitch, blade quantity, geometry, and dimensions including thickness, blade tip velocity, casing diameter, stator vane quantity, balked tip to wear-ring gap, impeller blade to stator vane axial gap, tailpipe nozzle geometry and dimensions (including diameters, shaft seal power loss, rotor masses and balance, manufacturing tolerances, fluid dynamics, sulfur-bearing grove pattern, geometry and dimensions), the shaft's Young's Modulus, and the shaft's dimensions, and critical speed, to suite the desired flow rate and the desired H₂S concentration reduction. The rotor speed may be adjusted down to approximately 500 rpm or as low as approximately 750 rpm. The minimum speed limit value is a function of the sulfur-bearing's minimum film thickness, sulfur-bearing bush, and shaft-sleeve diameter, sulfur-bearing grove pattern, geometry and dimensions, impeller diameter, blade pitch, nozzle diameter and desired flow rate. As the rotor's speed is increased, the pump's tailpipe nozzle flow may be decreased by decreasing the blade pitch.

In one embodiment, a rotary radial-flow impeller having a plurality of blades is presented in a casing draft-tube at a submerged location in the liquid sulfur surrounded circumferentially by a radial distributor. The distributor is a diffuser and includes a plurality of apertures or openings. The draft-tube is circular and its radius, and the distributor's dimensions, and geometry, and the rotor speed and the impeller diameter and impeller position, have effect on the dimensions of the central vortex. The open-area, hole size, and locations are predetermined and set per an electronic model. The circumferential area, height, geometry, hole diameters, and the open area ratio help create the central vortex, and simultaneously providing radial distribution of the pumped fluid including bubbles. The hole size may be decreased or is adjustable.

The quantity and the radial protrusion of the anti-vortex central baffles inside the draft-tube is now adjustable to near zero, or to any radial length that approaches the radial impeller. Radial vertical baffles need not be fitted, or conversely, any number of radial vertical baffles may be fitted. The parts may be adjusted to suit rotor speed, or the rotor speed may be adjusted to suit the fitted parts.

Accordingly, in an aspect of the present invention, an apparatus and method are provided for the processing of a hydrogen sulfide- and sulfur dioxide-containing gas stream to remove at least one of the components therefrom. This is accomplished using a uniquely designed impeller comprising a plurality of blades situated about a rotational rod or shaft along the vertical axis, submerged in the liquid sulfur, and surrounded by the draft-tube. The gas stream is then directed to the submerged location, and the impeller is rotated about the vertical axis at a speed capable of drawing liquid sulfur into the interior of the draft-tube, and distributing the gas stream as bubbles, forming a gas-liquid mixture, and flowing the gas-liquid mixture from within the interior of the draft-tube to the draft-tube exterior, thereby effecting reaction between hydrogen sulfide and sulfur dioxide to sulfur. In this manner, an original prior art design of utilizing gravity flow is replaced by the resultant pumping action of each degasser system tied in series, where the first degasser in the series receives fluid from an external pump.

A new method for a degassing unit pumping design was necessary to meet the larger capacity requirements for degassing systems. For example, the novel impeller was designed predicated in part on apparent flow. The pumping or flow of liquid sulfur, like water and air, may be considered as an inviscid, incompressible, irrotational flow. The study of the dimensionless and normalized characteristics and carrying out a modeling experiment by using one fluid instead of another fluid can be used as tools, but the methods are relatively expensive for investigating complex conditions such as two-phase flow or multiple moving geometrical structures. Utilizing traditional turbo-machinery velocity-vector (impeller) blade models and methods for designing pumps, as well as the velocity vector diagrams of propeller driven devices, such as for example, a sailboat, and applying Archimedes' principles, a new method for designing first article pumps became evident.

In one embodiment, a control volume (CV) is placed around the pump or around the impeller. It adds a new concept of apparent flow relative to a blade, which is analogous to a sailboat apparent wind method of boat speed optimization. Current methods generally model a pump in terms of flow velocities, and then determine blade angle and shape, etc. Whereas, the present method directly models the pump's most critical part (the lifting device) identified as the blade, and models the flow in terms of the fluid moving past the blade.

Adding an Archimedes' or screw-like fluid flow displacement or apparent velocity, as the blade moves relative to the fluid, allows the axial-flow portion of a pump to be modeled. The blade's angle of attack is first determined giving a resulting apparent velocity or flow, which enables rapid optimization of flow rate, velocities, and pressures for various blade or rotor speeds, various diameters, blade shapes, and angles of attack. The preferred method utilizes the determined actual angle of attack of the blade, and includes the blade's lift and drag, generally empirically derived, from actual blades, lifting surfaces, plates, etc., using a Reynolds Number scaling. The method also makes use of characteristic pump results and curves from a traditional turbo-machinery calculation, for guideline values, trends, or checks. The new method enables design and sizing of first article pumps, axial flow, mixed flow or radial-flow pumps for pumping sulfur, water, wastewater, or air.

It was realized that the theoretical flow rate, pressure rise or lift, and power of a rotor can be defined in theoretical laws for fans and pumps, and the actual values can be ascertained. In the present invention, the required power and torque are calculated for alternate impeller speeds and diameters using the actual known values, adjusted to alternate variables, based on the theoretical laws. This method has not been applied to designing a degasser before, as the degasser has never been recognized in the prior art as a pump, and thus pumping principals have not been applied to the application of a degasser. In the prior art, a degasser has always been viewed by engineers and chemists as a tank including an aggregator, where in the present invention it is treated and analyzed as a pump.

Fan or blade data for geometrically similar components may be collapsed into analytical expressions using dimensionless values for flow rate, pressure rise, and power:
a) Dimensionless flow rate Π=Q/(D³N)
   where
   Q=volumetric flow rate (m³/sec)
   D=fan diameter (m)
   N=fan rotational speed (radians/sec)
b) Dimensionless pressure rise ε₂=ΔP/(ρD²N²)
   where
   ΔP=fan pressure rise (kPa)
   ρ=fluid density (kg/m³)
and;
c) Dimensionless power Π₃=W/(ρD⁵N³)
   where
   W=fan power (kilowatts)

In the present invention, extra impeller blades are taught and utilized. The extra impellers could be made just light enough, and the shaft could just be made thick enough, and short enough, to make the cantilevered shaft design style sufficiently stiff to give a design speed on the order of 750 rpm or greater.

Two impellers were analyzed, and shown to achieve the desired results; however, shaft support was lacking, and the stiffer shaft tended to stress the sections. Additionally, it was determined that the fluid must be sheared as much as possible for the degassing aspect of the design. Thus, although a two impeller design is acceptable, an additional impeller proved more effective, but may require a stator for stabilization purposes.

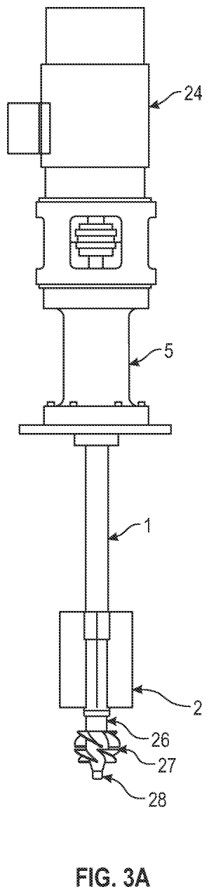

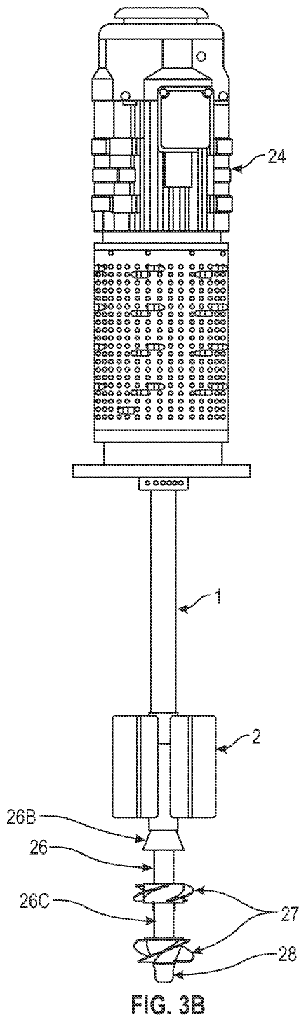

The proposed impellers are distinguished on the shaft as three distinct impeller or blade sections: a) a radial flow section; b) a mixed flow section; and c) an axial flow section. FIG. 3A depicts an elevational view of the inner workings of an embodiment of a degasser rotor assembly. Shaft 1 is depicted extending axially downwards. A rotor drive 2 houses the radial flow section of the rotor or impeller. Impeller spacer 26 separates the axial and mixed flow impeller sections 27 from the radial section within impeller drive 2. Motor 24, secured on motor mount base 23 drives shaft 1, with both in mechanical communication with bearing housing 5. The axial and mixed flow impeller sections 27 are positioned and secured on the shaft by torque bolt 28.

FIG. 3B depicts the mixed and axial flow sections of the impeller of another embodiment the present invention. Axial and mixed flow impeller sections are separated by impeller spacer 26c. The radial impeller is separated from the axial impeller by spacer 26a.

It is further noted that the aforementioned design may be combined into one impeller. Generally, this can be performed with a mixed flow to a more axial flow design, and the swirl from the axial flow could continue to form radial flow. However, there may be a loss of shear without placing stators therebetween. Essentially, the impeller of the radial flow section may be omitted or may redirect the flow radially, if air is included, injected, or drawn into the intake, prior to the mixed-flow and axial flow impeller sections. The mixed-flow and the axial flow impellers may be used to generate small bubbles.

The design of the radial flow section within rotor drive 2 is to dedicate blades to generate small bubbles, entraining them in the liquid. This is accomplished by introducing high tip speed, spinning the radial flow impeller to generate a large quantity of small bubbles in the liquid. One advantage over the prior art is the compactness (weight and size) of the radial flow impeller. Generally, in order to generate high tip speed and maximize bubble formation, the impeller is upsized for strength and stability. In at least one embodiment of the present design, the radial flow section impeller may be smaller and lighter.

The radial flow impeller is designed to develop an air-core or vortex that extends towards the bottom of the radial impeller, or below, depending on the blades' speed and diameter. Blades of the radial flow section of the impeller direct fluid radially outwards in the degasser. A core vortex is developed down the axial center of the radial flow section. The vortex draws (sucks) air from the atmosphere such that the top portion of the radial flow section directs ambient air downwards into the fluid, while the fluid, conversely, is directed upwards. The velocity of the radial flow section blades is a predetermined speed to optimize the movement of a large number of fine spherical bubbles—as tiny and numerous as possible. The volume of inward air is governed by the central vortex. Alternatively, sparge or stripping gas or inlet gas may be introduced prior to the radial flow section or in the intake if central vortex air core entrainment is insufficient or not desired.

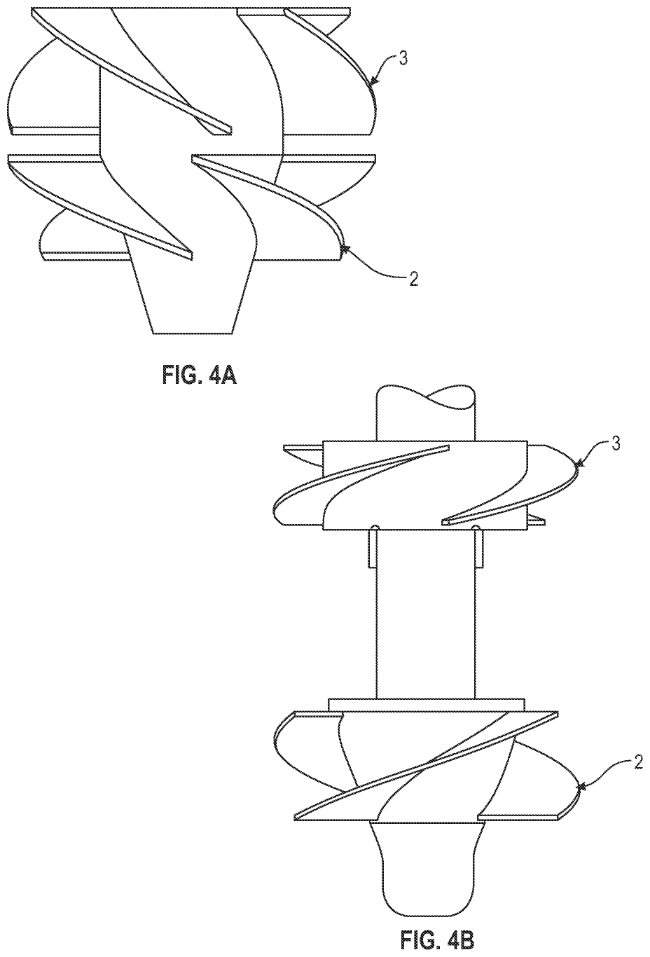

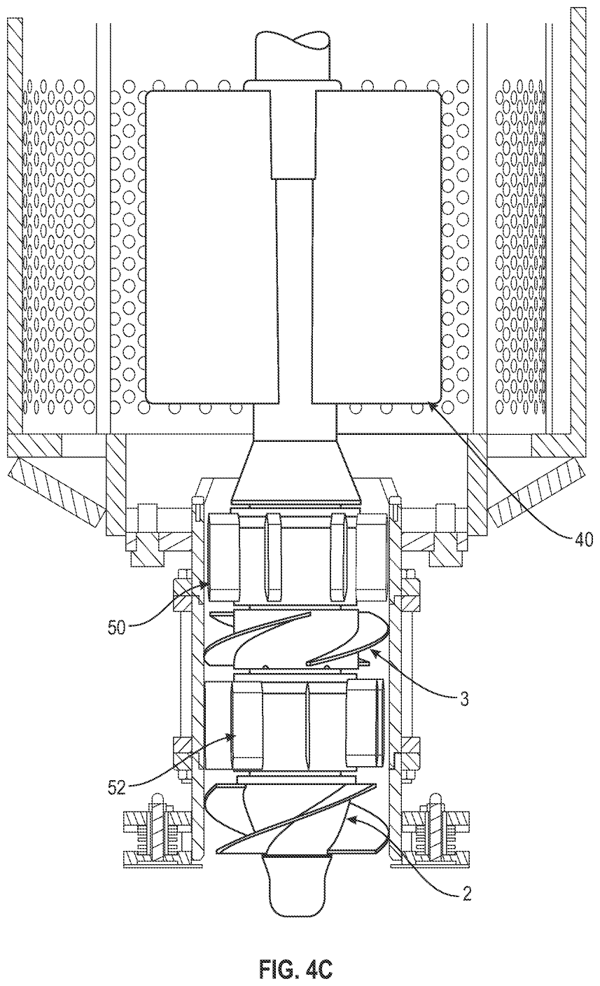

The mixed and axial flow sections 27 are identified in FIG. 3. FIG. 4A depicts a detailed view of the blade portions for the mixed and axial flow sections of the impeller of the present invention. Mixed flow impeller section 2 is shown with its blades axially below axial flow impeller section 3, while both impeller sections 2, 3 are attached to shaft 1. Blade leading and tailing edges are also depicted. The blades may be designed such that a trained service technician may adjust the blade angle to suit actual conditions on site, slightly, by a few degrees, by physically bending blades. The blades are preferably made from stainless steel that is tough and yet may still be bent. The blade thickness is relatively thin, approximately 3 mm (⅛-inch) to about 5 mm to minimize the weight, and allowing the material to be bent using hand-tools.

FIG. 4B depicts a detailed view of the blade portions for the mixed and axial flow sections of the impeller of a second embodiment of the present invention. Mixed and axial flow sections are spaced apart.

FIG. 4C depicts a detailed view of the blade portions for the radial, mixed, and axial flow sections of an embodiment of the impeller design;

Cost of impellers may be minimized by using a welded impeller, machined after welding to fit. One type of preferred material is 316/316 L type stainless steel, which is approximately 2.9 times stiffer than aluminum 6061-T6, for example.

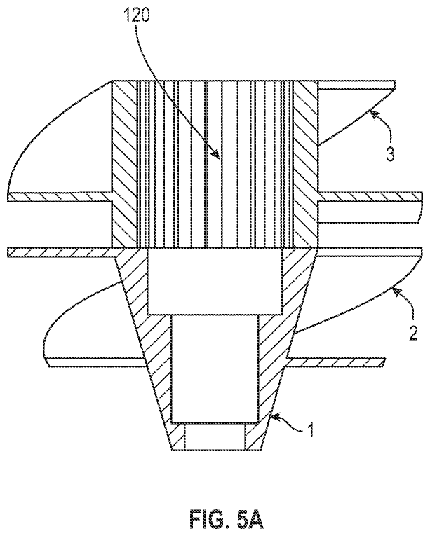

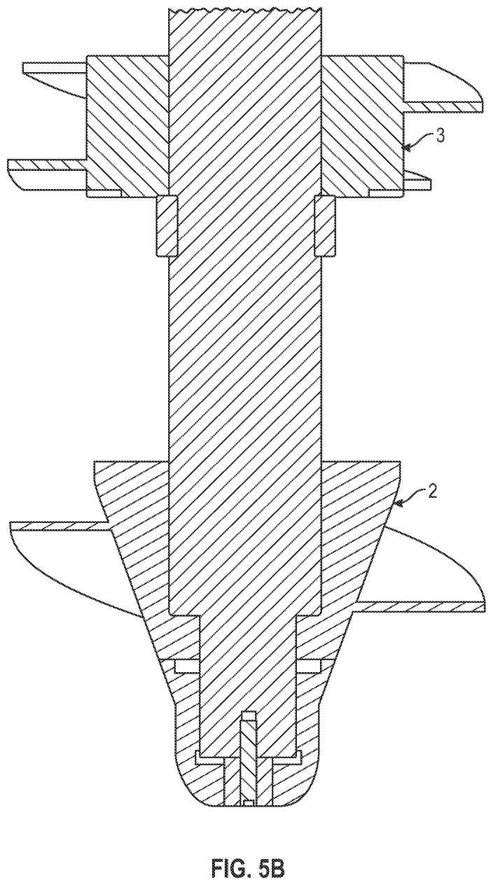

FIG. 5A depicts a detailed cross-sectional view of the mixed and axial flow sections of the impeller portion of FIG. 4A. FIG. 5B depicts a detailed cross-sectional view of the mixed and axial flow sections of the impeller portion of FIG. 4B.

The mixed flow section 2 of the impeller is designed provide aeration and transfer fluid to the axial flow section. The mixed flow impeller also adds to the pump's ability to draw liquid including bubbles, air, or entrained gas up towards the axial and radial flow sections. Thus, the mixed flow section helps facilitate the pumping action of the degassing unit.

It was found that single stage axial impellers stall, loose pumping ability, or initiate excessive cavitation when bubbles or gas is present. In order avoid such excessive cavitation, or to draw liquid including air or bubbles, the present invention included in at least one embodiment a mixed flow impeller. Alternatively, a second, or a second and a third axial flow impeller may be used instead of the mixed flow impeller. Although mixed-flow or multi-stage axial pumps are not self-priming, they may be designed to sustain a suction lift of the incoming fluid.

Relatively thin plates for the blades of the mixed flow and axial flow impellers are preferred, utilizing lightweight, relatively low-cost materials, and low thickness values at the leading edges promotes suction performance. For example, inducer pumps may have very low thickness values at leading edges to improve suction performance: 6%-10% of normal blade thickness.

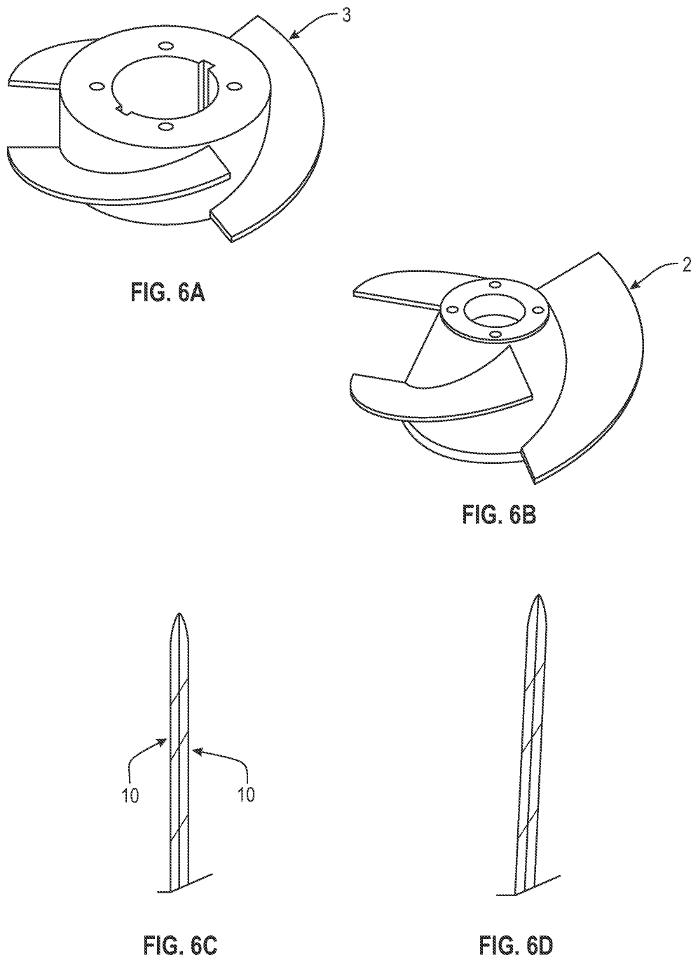

FIGS. 6A and 6B depict the location of the leading and tailing edges of an axial flow impeller (FIG. 6A) and mixed flow impeller (FIG. 6B). FIGS. 6C and 6D represent cross-sectional views of the impeller tips of FIGS. 6A & 6B respectively, depicting the leading edge and the tailing edge. Both front and rear surfaces 10 are smooth to a uniform curve. Any flats in the surface will reduce pumping flow or pressure-rise efficiency and cause cavitation that may or may not be desirable, depending on pumping unit's configuration.

No guide vanes need be employed after the mixed flow impeller. This, in turn, reduces cost, although guide vanes may be added, or vanes may be employed after the mixed flow impeller as an option to reduce power consumption or to increase fluid's shear.

Additionally, there are no guide vanes introduced after the axial flow impeller, as the bulk internal fluid is entrained. The bulk internal fluid is then sent to the axial flow impeller's outlet, axially upwards, towards the eye of the radial-flow impeller which is attached and supported on the common shaft.

A gap is designed between the mixed flow impeller and the axial flow impeller effectively creating tandem rows or stages of blades, such that each row or stage is separated and optimized for actual conditions at the blade location. The blade angles of the first stage may differ from the second stage, for example, to address excessive or unstable cavitation.

The rotor to casing gap will increase in service from wear of the impeller or casing. The impellers and casing are wearing parts, for renewable clearances. Renewable clearance may be addressed by replacing bolt-on parts. A wear ring or wear sleeve may be added or inserted into the casing if desired instead of replacing the casing.

Once the liquid is inside the degasser's housing, the axial flow impeller adds to the recirculation of the liquid and bubbles inside the reactor. The speed, diameter, and blade angles of the axial impeller are set or adjusted to limit the exit velocity from the axial-flow impeller, so that the liquid does not overwhelm the air core or central vortex created by the radial-flow impeller. The vertical space, gap, or height between the axial-flow impeller's exit and the radial-flow impeller's inlet gives time for gravity to act upon the liquid and limit its rise vertically.

### Additional Attributes

Past systems were gravity flow, including liquid flow from the highest level in the first reactor to the lowest level in the last reactor. Embodiments of the present invention include units that may draw flow from a lower level to a higher level, or an upstream reactor may even draw from a down-steam reactor, recirculating the flow within a group of reactors within a system.

This mechanism and method of operation are novel contributions to the art. The proposed designs greatly improve the effective residence time of a volume of gas in a volume of liquid for a given production rate, and significantly increase the shearing of the fluids, and the reactivity. Effectively the degassing unit, acting as a pump, is the contactor, and gas may be injected. Air can be the superior degassing stripper gas or reactive agent in some situations compared to inert gases such as nitrogen. In at least one embodiment, a new seal design, joint designs, and new materials of construction, extend possible use of the design to new applications that were in the past impractical. For example, due to the enhanced sealing attributes, it is now possible for an embodiment of the proposed invention design to receive an inlet gas mixture including H₂S and SO₂ gases typical of a Tail Gas Composition for reacting and transferring the H₂S to the liquid, and recycling the system's liquid sulfur and exhaust gas outlet back to a Sulfur Recovery Unit (SRU) for improved total containment of sulfur. Inlet gas mixtures may be received at pressures of up to approximately 70 kPa and inlet compositions may include H₂S and SO₂ at concentrations that are higher than typical Tail Gas Composition values.

Gas or air inlet is typically air; however, the source may be a slipstream from the Tail Gas Treatment Unit, nitrogen, or some other source. The inlet gas in the present configuration is typically air, but the inlet gas or the sparged or injected gas may be air, nitrogen gas, an inert gas, or a low oxygen-containing inert gas, or a non-inert gas containing oxygen or sulfur dioxide. It should be obvious, the H₂S and the SO₂ concentrations in the actual gas have effect on the chemical reactions and the outputs.

Oxygen may not be required for removing hydrogen sulfide from the liquid, but an air or an air-like mixture can be practical, particularly when a degassing system includes gas outlet piping that is constructed from carbon-steel, if the contact surfaces are self-draining and maintained at a temperature value that is greater than the dew point of elemental sulfur. There can be less corrosion of construction materials in dry non-condensing environments. A dehumidifier or a heater may be added to preheat or decrease the relative humidity of the inlet air.

Presently, the pumping unit is configured for ambient pressure or low-pressure use. Alternatively, the pumping unit may be configured for high-pressure catalytic H₂S conversion to sulfur in a liquid-sulfur medium, for example at an operating pressure of approximately 1000 psig for minimizing equipment size. A solid catalyst may be included into the pumped fluid's flow. A pressure of a least approximately 40 psig may be used. Alternatively, the pressure may be less than approximately 40 psig. Alternatively, pressure may be less than approximately 36 psig, and may be approximately 0 psi, and may be in the range from approximately 1 to 8 psig, or approximately 1 psig to 13 psig, or approximately 7 psig to 17 psig, or approximately 5 psig to 30 psig, or approximately 5 psig to 200 psig, or other pressure range that may be necessitated by an active agent.

Air is drawn into the unit by the central vortex, which is used to created bubbles. Alternatively, air or a gas may be injected into the liquid sulfur at liquid jet's nozzle exit, or prior to the radial-flow impeller, for same purpose; that is, the creation of bubbles and avoid the need to create central vortex to draw air. This may affect rotor speed to an effective vortex depth of less than the liquid head height of an immersed bearing.

### Compact Footprint

Past reactors used splashing, vigorous stirring, or agitation, or vigorous agitation by bubbling, or bubbling or sparging (chemistry) methods that required a relatively voluminous container, an ancillary agitator, a pump, and a blower or a motive force device, whereas some embodiments of the present invention include an intensive degassing pumping unit that includes the reactor. The units are compact enough to be transportable. It is estimated that the current reactor will reduce the footprint by approximately 40× the current prior art designs.

The small size means the major assemblies and the parts can be cost effectively constructed of corrosion resistant materials. The relatively low external surface area and the relatively high production rate mean the internal fluid temperature distribution is relatively uniform and suitable warm. The unit is thermally insulated; the production rate is adequate to maintain heat balance. The in-service heat load is typically negligible compared to a sulfur tank, sulfur pit or vessel.

### Liquid Surface

The liquid surface within the housing is a barrier. There is one surface barrier at the outlet. The barrier prevents the exhaust air outlet blower or fan from sucking or drawing, short-circuiting, the inlet gas to the outlet. There is one surface barrier at the inlet, inside the reactor core. The barrier, and the surface enables the central vortex to draw air from the inlet into the liquid. The barrier has two sides, and it has an air—sulfur interface (air side), and a sulfur—air interface (sulfur side). The air side area at the barrier (within the housing at the air outlet region) has a relatively small in area compared to the total bubble surface area, as the bubbles aggregate and break at the barrier, releasing significant mass of gas to the outlet. Prior to the barrier, the immersed bubbles provide a relatively large interface area, and they too have an air side (inside the bubble) and a sulfur side (outside the bubble). Empirical evidence has shown how this arrangement may be used to minimize the mass of sulfur gas in the exhaust air mixture. The relative surface area of the barrier may be decreased relative to the unit's production capacity, if desired, to change or decrease the footprint, which may be round or rounded-shape instead of square or rectangular footprint, to decrease the potential for accumulation of solids, or to decrease the manufacturing cost of a unit. The new design's outlet liquid-surface area inside the pump's housing is relatively small compared to the unit's production rate, which is intentional. Sulfur has a vapor pressure. The evaporated mass of sulfur in the gas outlet is decreased by used of the smaller surface area. The pump operates with elemental sulfur gas adjacent to the elemental sulfur liquid. It operates with an exhaust air outlet pressure that is barely below atmospheric pressure. The relatively small liquid surface area and the negative-pressure that is relatively near atmospheric pressure above the liquid's surface at the outlet minimizes the evaporation of the elemental sulfur to the exhaust. A strong vacuum should not be drawn on a sulfur that is in the liquid phase to avoid drawing-off the sulfur product as a gas of elemental sulfur.

### Reagents

Care is taken on selection of proprietary reagents. High purity elemental sulfur is output, chelates of polyvalent metals are not added, metal containing active agents and high-boiling point liquids are not added, and those agents their products are not output in the sulfur.

Although ammonia (NH₃) gas may be an active agent for degassing liquid sulfur, it is typically not recommended or may be considered an impurity that produces unwanted salts that are insoluble in liquid sulfur, which can coat the inside of piping or clog nozzles that may require routine cleaning. Active agents should not create ash. It is desirable that no ash be produced, which may float or sink or clog nozzles or require removal.

A catalyst is typically recommended to convert H₂Sₓ to H₂S for efficient removal of the H₂S. The catalyst used in this invention is typically a blend of chemicals. The blend will include an active agent that is a catalyst, and may include an active agent that is a surfactant for H₂S transfer or degassing purpose. Various surfactants are commonly known, which lower the surface tension between a gas and a liquid, or between two liquids, or between a gas and a solid, or between a liquid and a solid. The catalyst blend is commonly known to be removed by the last reactor. What may be not obvious is an agent may be added, which may exit the system for use downstream by design. For example, an exit agent that decreases the sulfur's wettability may reduce the water consumption of a wetprill type sulfur forming unit.

The unit includes an opening (one or multiple openings) for injection of reagents or catalyst. The catalyst may be injected or included in the air or gas. It is preferable the greatest concentration of catalyst is in the liquid adjacent to the gas or bubbles, where H₂Sₓ should be H₂S to cross from the liquid sulfur to the gas or bubble for liquid-gas separation. Injection of the catalyst into the gas can achieve this condition in some configurations. For example, if the catalyst fluid or gas selected travel across the air or gas boundary with the liquid, and if the reagents and the catalyst or active agent is warmed sufficiently, so temperature does not adversely affect the flow or reaction activity, then a high local concentration of catalysts occurs, and the average concentration is much lower. In one embodiment it may be easier to increase reactivity for a given amount of catalyst, or alternatively, it may easier to remove the catalyst, or the catalyst included at the unit's outlet may be low enough to not require removal, or units dedicated to catalyst removal may not be required in some degassing system configurations.

### Solid Catalyst

In one embodiment, the present invention introduces a catalyst that is a gas or a volatile liquid. Alternatively, the catalyst may be a solid. The degasser pumping unit may be combined with the use of an existing or new solid catalyst. In units that include the solid catalyst option, the solid would be immersed in the pumped fluid's flow, for example it may be a pressurized monolith, or it may be the surfaces of the stator vanes or within the tailpipe outlet nozzle, or the radial-flow distributor of the casing draft-tube, or within an outlet of a unit. The solid catalyst may be part of a unit, or the solid catalyst may be of a block-like, porous-solid, granule-like, or pellet-like material that is sufficiently constrained for operations' purpose within a dedicated volume inside the fluid being reacted. The solid catalyst may be included within the pumping unit or within the interconnection piping of a degassing system, wherever within the degassing system the desired volume surface area is immersed and contacts the fluid being reacted should be sufficiently economical. The pumping would push liquid sulfur through the monolith. Alternatively, the pumping unit may would push liquid sulfur and the stripper or sparge gas fluid mixture through the monolith. The pumping unit may be configured to develop a pressure difference across a catalyst of less than 1 psi to 40 psi, or a greater value, as rotor speed increases and as more pumping stages are added.

Typical solid-catalyst materials include alumina, that is aluminum oxide, and titania, that is titanium dioxide, and similar, react more with hydrogen polysulfides to hydrogen sulfide. Aluminum oxide is the material of the passivation layer on an exposed aluminum surface that is normally maintained as an oxide, which makes the metallic aluminum resistant to weathering. The surface of titanium metal and its alloys oxidize in air to form a passivation layer that protects the bulk metal from further oxidation. Prior to selection of a solid catalyst contact material, it can be worth-while to experiment with the life of the solid catalyst in the fluids by testing. Sulfuric acid will react with aluminum oxide, however the lifetime may be acceptable if new material is made available, if there is no sulfuric acid in the fluids. Aluminum can be a cost-effective construction material. Dilute sulfuric acid may not react with titanium oxide, or may be preferred in dilute acids are present. Pumping unit assemblies or internal parts may be constructed of a steel alloy such as a stainless steel, or may be constructed of an aluminum alloy, titanium alloy, composite material, or of a material in a manner that may include a catalyst material for hydrogen polysulfide to hydrogen sulfide production.

The pumping unit works by converting the power that is input to the shaft to kinetic energy of the fluid, which is now available to increase the fluid's velocity past surfaces and is now available to increase the fluid's pressure head, to enable the fluid to pass through or around contacting surfaces that may include solid catalyst material, to overcome the associate fluid-flow pressure losses. The reactor's catalyzing system presently incorporates a single-catalyst primary reaction; however, the catalyzing system is now able to include dual-catalyst reaction conditions, or may include three or more catalyst materials and conditions.

Previously, it has been necessary to use a pit, a tank or a pressure-vessel, rather than using the pump as the degassing mechanism. Previously, if a solid catalyst were included, then a dedicated contactor apparatus was used, which often included use of a sparge-gas, wherein some configurations require a packed-column or a tower. The allowable sulfur pressure drop or the surface contactor area of the catalyst was limited to in-pipe values that affected the size and the cost. Porous and granule-like catalyst solid media is available and may be included in the new degassing system as an option, however if the sulfur may include solids, then a gas phase or a volatile liquid may be preferred. Alternatively, the surfaces of the solid catalyst material may be arranged inside the pump in manner that decreases the risk of clogging, or increases the time between servicing or the reactivation, or increases the time between replacements of the catalyst material or parts including the catalyst contact material.

The draft-tube radial-flow diffuser, the tailpipe nozzle, the baffles, weirs, or outlet may all include solid catalyst. The solid catalyst may form part of the surfaces of the unit's wetted pumping parts, or may be a replaceable element, module, or assembly including solid catalyst, which may be replaceable while a pumping unit is in-service, warmed-up, drained, paused, stopped or shutdown.

Other design attributes beyond the novel rotor and impeller designs involve the draft tube, radial vertical baffles, horizontal baffles, vertical baffles with underflow weir, and overflow weir. New designs of all features, parts and assembly include materials of construction for sufficient life with reasonable price in the intended service. For example, with trace or no sulfuric acid in the liquid sulfur and less than 1% w/w H₂S inlet concentration a 316/316 L type stainless steel or a 316 L type stainless steel may be the materials of choice for an assembly or a part. At higher H₂S concentrations, and/or higher pressure than near atmospheric pressure, and/or if sulfuric acid may be present in the liquid sulfur, then various other type of stainless steel, or alloy or synthetic material may be better suited. More life-time from a less acid resistant material may be achieved by making sulfuric acid concentrations homogenized in the liquid mixture, so the acid does not concentrate in one local spot and so it does not accumulate.

The circumferential open area of the draft tube (hole diameter of the pump's diffuser/distributor/draft-tube system including submerged orifices) is increased to let the extra potential flow from the axial impeller pass through it radially without excessive head increase inside the draft-tube. This will assist in the creation of the circular central vortex. It was discovered, the open holes are not an absolute requirement to achieve degassing; however, the casing draft tube supports the bearings and has effect on the diameter and depth of the central vortex (air core) that must have sufficient depth for creation of bubbles. The hole open area has effect on the outlet flow distribution from the radial flow impeller, which includes bubbles. The open area should be great enough to allow radial flow through it without excessive head height or buildup of liquid inside the draft-tube. The holes should be sufficiently numerous and separated, to distribute the flow radially inside the housing. The edges of the holes should be relatively sharp to shear the liquid. There should be sufficient edge-length for this purpose. There may or may not need to be vertical baffles, depending on diameter, depth, and speed of the radial-flow impeller to develop the necessary central vortex and blade-tip speed.

In order to increase the reaction products of the chemical reactions between air and liquid, it is necessary to keep the bubbles, air or gas in the liquid for a longer period of time in the same footprint. This is achieved by adding a horizontal baffle. A unique feature of the baffle are radial slits to allow the baffle's inner circumference dimension to increase in size relative to the outer dimension, as the unit warms up. The inside circumference is warmed-up by the degasser cover during starting whilst the outer circumference may initially be at ambient temperature or 120° C. or relatively cooler than the heated cover's local temperature. If thermal expansion is not considered, then the baffle may buckle or may be stress or strained more than desired, which may not be obvious. The baffle is sufficiently stiff or thick to not resonate with the rotor or passing fluids.

When the rotor is moving (and when the rotor is paused), a vertical plate in the vapor or gas-space is immersed in the liquid creating a horizontal gas seal at the liquid's surface. This plate prevents any downstream exhaust fan or blower from drawing ambient air, and prevents a downstream blower from applying a vacuum above the surface of the central vortex. If this baffle or plate were not present, then the degassing unit (pump) would be less effective at drawing air into the liquid, as it would be operating against the downstream blower. The downstream blower is not required for function, but users often desire a blower on the outlet to control gases, such as sulfur dioxide, which exit the unit.

Elemental sulfur has a vapor pressure, and it may be a solid, a liquid, or a gas, or all three. The speed or suction setting of a system's suction fan or blower should be approximately atmospheric pressure. If a user's downstream suction or vacuum is excessive, then excessive sulfur in the gas phase will be drawn into the downstream piping (after the unit), which may condense as a liquid, and solidify as a solid (below approximately 120° C.). If the sulfur condenses or solidifies downstream, it may affect function of the piping or unit operations.

Similarly, if the downstream suction device is set to create excessive suction, then this will have an effect on the liquid flow capacity of the unit, as it will attempt to draw on liquid that is exiting the unit. Downstream suction should be controlled, limited, or considered, when the degassing unit is being used for degassing liquid sulfur.

The novel axial flow impeller style requires a relatively high net pressure suction head (NPSH) value compared to radial flow impeller styles that operate with a relatively low NPSH. To increase the potential NPSH by an increase of the fluid's density, or to make the inlet pumping possible, or to prevent the bubbles, a vertical underflow weir was added, which in turn keeps the bubbles within the reactor as much as possible. Similarly, the overflow weir includes a rounded-crest cross-section with a radius of greater than approximately 3 mm or greater depending on the average crest flow velocity and the weir's head-height, or radius of approximately 5 mm in this example, to encourage a clinging flow over the weir's crest to reduce creation of bubbles and encourage disengagement of gas, as the liquid overflows and flows downwards from the crest. The overflow weir is vertical or down-slopping to reduce gas being drawn into the liquid as it travels down the weir to the outlet. The outlet pipe includes sufficient cross-section for the unit's design throughput capacity to disengage the gas from the liquid prior to the liquid being drawn out of the unit. The overflow weir is a labyrinth type that is star-shaped, which increases the effective length of the weir that minimizes the required head of liquid above the crest, which minimums the vertical height of the housing, size and cost. The internal star-shape also tends to straighten the flow axially and avoid or dampen development of circumferential central vortex as the liquid disengages from the vapor-space interface and fills and enters the outlet.

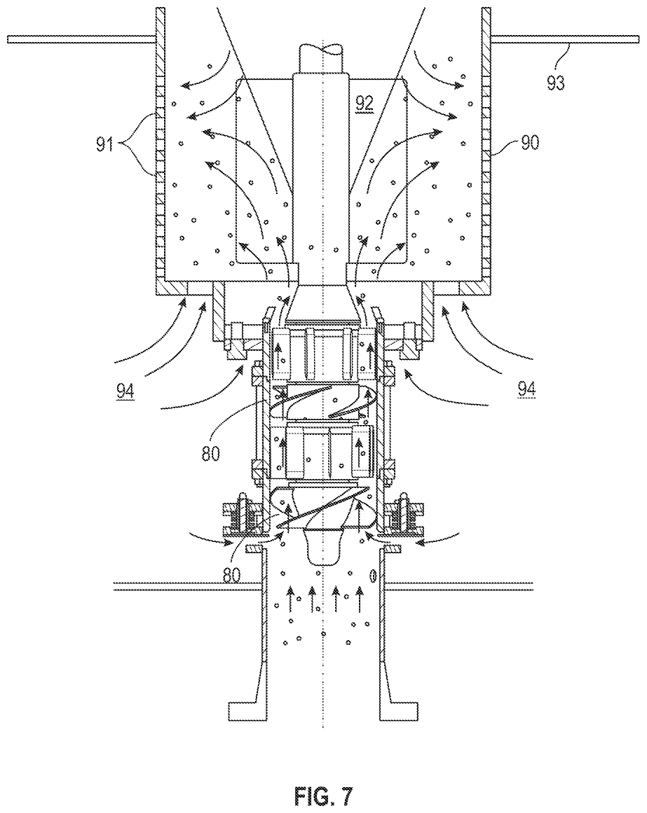

FIG. 7 depicts a schematic of the degasser impeller design and the directional flow of the fluid and bubbles entrained therein. A draft-tube 90 with open holes 91 surrounds a radial impeller drive portion 92. A horizontal baffle 93 is shown at the upper portion of the draft-tube. The shaft assembly is located in the axial center of the system. The arrows 94 presented indicate flow direction. In this embodiment there are two axial flow impellers 80 with an equal number of blades. A gap separates the radial flow drive housing from the axial flow impeller.

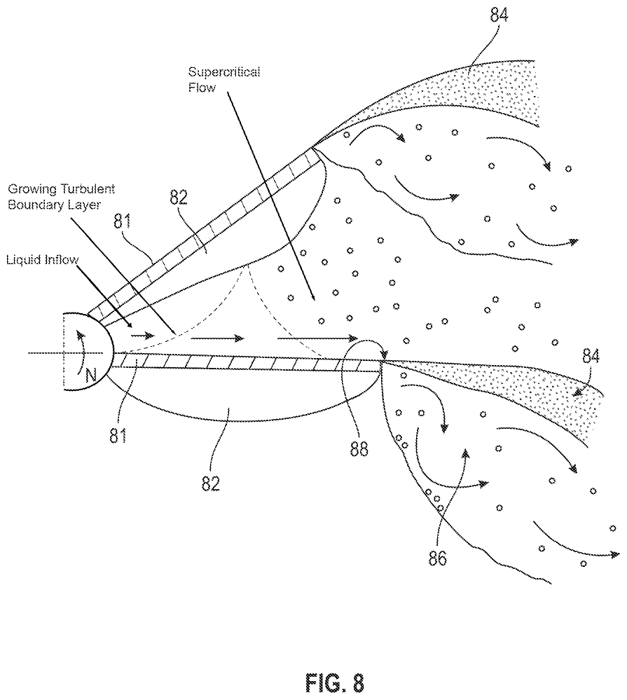

FIG. 8 is a schematic depicting the fluid flow about radial flow impeller blades 81. A growing turbulent boundary layer is generated when the shaft is rotated at a predetermined rotational speed. Air pockets 82 develop behind the blades, and super-critical flow is established between blades, which assist in creating a submerged hydraulic jump. At the impingement point of each blade, a turbulent shear region 84 is established in conjunction with a recirculating roller or vortex region 86. Air entrainment at the impingement point 88 results in a large population of bubbles downstream. The bubble population is a function of the rotor rotational speed. In this embodiment, the shear generated is greater for a given motor and drive system typically found in the prior art.

To maximize degassing reaction or cut degassing time, shear is maximized. This maximization is accomplished by the radial flow impeller, vortices, generated turbulence, and maximized the tip velocity. With the self-air entraining radial-flow impeller, the maximum shear is limited by the size of central vortex or air-core, available power, sulfur temperature, blade-tip velocity, blade length, and submergence. The tip velocity is function of shaft speed and the radius of the tip from shaft's centerline.

The degassing reaction rate increases with temperature; however, the sulfur's viscosity increases as its temperature exceeds approximately 160° C., which is non-intuitive. When the fluid temperature value rises, the sulfur's viscosity also rises, which affects the shape of the central vortex, the power requirement, the fluid flow velocities, and the vorticity, turbulence, or shearing of the fluids. Shear for degassing purpose may be limited by the bulk liquid temperature or the temperature of the liquid sulfur during pumping operations, and may be adversely affected by dynamic vicious heating from shaft power input. Air or gas may be separately blown or pumped into the liquid to reduce the shaft power input into the liquid for air pumping purpose.

### Overflow Weir

The overflow weir controls the depth of the liquid inside the degasser's housing. Liquid exits over the lip of the overflow weir, and is directed or plunges downwards by gravity into a standpipe. The diameter, height, and volume of liquid in the standpipe are sized to avoid central vortex formation, or excessive air or gas entrainment into the liquid at the exit. It is sized to give enough time for air or gas entrained by the overflow weir's plunging jet, to disengage from the liquid prior to the liquid exiting the unit. In prior art designs, the standpipe including overflow weir were sized based on empirical data, and for operation at relatively small flow rates.

For modeling purposes, sulfur's fluid dynamics may be scaled relative to water when the sulfur is in its (melted) liquid state at a temperature of approximately 120° C. or just above its melting point; however, sulfur's viscosity increases exponentially, as its temperature is elevated above approximately 160° C. Chemical reactions such as hydrogen sulfide degassing require the fluid temperature to be as high as possible, or in a specific temperature range, and not too high or the fluid's viscosity rises, which in turn limits the practical operating temperature window for sulfur degassing.

Empirical data has shown that the overflow weir pipe's diameter should be approximately 24″ diameter to limit the liquid head above the crest to a value of less than approximately 1-inch at higher desired production rates. The weirs may be circular in plan-view, or may be square or rectangular, or some other shape, in plan-view, not limited to the shape of a round standpipe or straight channel.

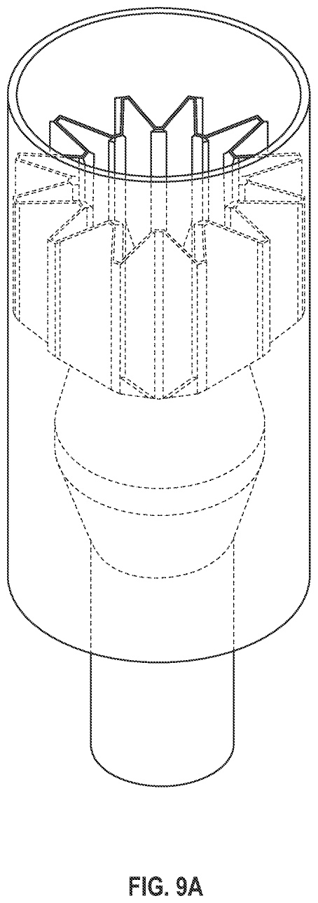

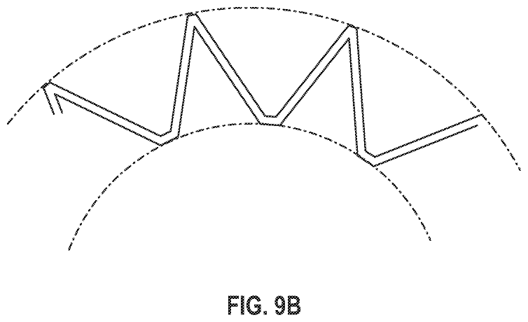

FIG. 9A depicts an embodiment for the overflow weir 111 of the present invention. Preferably, the overflow weir 111 includes multiple sectors 113 welded together to give the weir length. Fluid is introduced via a vertical baffle with underflow weir 115, and traversing up the standpipe until it reaches the top of the overflow weir, where it then proceeds via gravity downwards within the weir towards the flow outlet 117, which is in fluid communication with the fluid input of the next degasser in series. Preferably, the overflow weir includes a corrugated type cross-section, comprising segments split longitudinally and welded lengthwise. The “wavy” or sinusoidal cross-sectional shape, or triangular or trapezoidal shape, (extending radially inwards) increases the length of the weir, which in turn minimizes the head required, and maximizes the capacity without altering the existing vertical height of the degasser. FIG. 9B depicts a partial cross-sectional view of a trapezoidal labyrinth of the overflow weir 111. This design assists in controlling the height of the fluid, maintaining constant liquid level in the degasser system, while minimizing any fluctuation in the liquid level.

Furthermore, a screen may be placed in the inlet of the standpipe to make the velocity distribution more uniform into the outlet of the degasser. A screen may also be placed immediately prior to the inlet of the pump's impeller to make the velocity distribution more uniform into the inlet of the first impeller.

An internal bypass flow may be added for adjustment of the reactor's internal flow or its internal recirculation or contact time. The new degassing system may operate at a similar, or lower temperature, by using motor power more effectively, to increase contact time or recirculate fluid inside the reactor with help from the newly added axial-flow impeller.

To assist with assembly, the rotor and casing are designed to be one piece, and the rotor or impellers may further be trimmed or shimmed to give a gap (preferably 0.5 mm) to the casing. The gap is adjusted by insertion of shims at bolted flanges, and the diameter of new impellers may be set or trimmed to suit the actual diameter of the casing, wear-ring, or wear sleeve.

Adjustments may be made during operations when paused or stopped. The new design includes a casing that is adjustable vertically relative to the cover and housing by use unique heated joint assembly that is sufficiently strong and stiff to hold the casing including rotor, and yet allows the casing's inlet to be adjusted vertical relative to the sulfur intake, to adjust internal recirculation or (suction) load on the pump. Low pressure steam is used for heating the joint. If the joint were not heated, then sulfur would condense and freeze the joint solid, which would fail to function. The joint's design includes sufficiently flexibility to allow it to grow thermally during warmup relative to parts that may be at ambient temperature or may be preheated to 120° C. during starting to allow unlimited thermal cycling. The joint is vertically and torsionally stiff relative to the cover and the housing, which is desirable for avoiding resonance with the rotor that is supported within the casing. The casing's main flange includes jack-bolts for helping with lifting, for replacement of shims, to set the height of the casing's inlet relative to the housing's sulfur intake. The casing, rotor and drive sub-assembly is relatively heavy, for example a configuration for a nominal 2,200 tpd capacity may have a mass in the range from approximately 1271 kg to 1276 kg without the motor. A typical 40 hp explosion proof motor may add an approximate mass of another 378 kg to lift. This jacking or adjustment feature enables the (suction) load on the pump to be increased, if greater suction ability is required to overcome inlet piping pressure drops, but placing intake joint in the sulfur inlet pipe. If greater inlet sulfur liquid-drawing is not required, then the casing's intake may be adjusted upwards to create gap for fluid to recirculate inside the housing. Alternatively, it may be necessary to recirculate fluid inside the housing, to avoid running the pump dry, if the available inlet flow is unable to maintain liquid level to the lower bearing's level.

The intake has an available optional sprung diaphragm joint to increase suction pump load with leak-tight seal with the inlet flange. Springs provide sufficient face to hold the diaphragm in place. The diaphragm of H₂S resistant elastomer material allows for radial and angular misalignment of the sealing faces. Alternatively, closed-cell sponge rubber of H₂S resistance may be used.

Another mechanism or another method of adjustment is the rotor speed. The rotor's speed may be decreased or increase to adjust the flow rate or suction and this may be the most convenient method of adjusted, if an electric motor with an electronically adjustable VFD is fitted, and the desired speed is greater than minimum for bearing, and if the desired speed is not excess (so the depth of the central vortex (air-core) is not excessive of runs bearing dry), and if the fitted rotor and casing parts allows it. Alternatively, the impeller's pitch may be decreased or increased to adjust the flow rate, but this is costlier than adjusting the casing upwards to decrease suction or flow into the unit.

The diameter of the tailpipe outlet nozzle is another mechanism that may be adjusted or replaced to increase or decrease the flow (back-pressure), but this is typically only if an impeller of a given flow rate needs cavitation adjustment or to help work with an actual inlet piping configuration.

Large diameter main O-rings of approximate ½ “and ⅝” uncompressed section diameter were introduced in designs to seal relatively coarse manufacturing dimensional tolerances of housing-cover, and cover-casing bolted joints, to decrease manufacturing cost and time. Such large size O-rings have never been used before in a degasser or a sulfur pump, but chemical resistant materials found available, which are suitable for service with H₂S and sulfur at required temperatures. The new design achieves the necessary sealing of sulfur and H₂S at elevated temperatures. The previous main joints were unconstrained (compressible) silicone sponge-rubber joints that would not allow the new invention's casing intake to be accurately placed at its housing inlet to seal for a loaded (suction) pump condition, and previous joint elastomer was not recommended for long-term operation in the new service including potential for greater than approximately 1% v/v H₂S in the first stage reactors.

To obtain a sufficient natural frequency of vibration value from the shaft assembly, the shaft's diameter was maximized by use of splines 120 instead of keys to locate the impellers on the shaft. The splines removed less of the shaft's diameter than a key or keys. FIG. 5A depicts the splines on the shaft.

In order to achieve the desired design speed for the reactor, the impeller size needed to be decreased sufficiently to reduce weight, and by using splines the impellers may be fabricated from relatively dense or heavy stainless steel.

### Rotor Bearing Design

The main shaft material of a rotor design is typically stainless steel type 316, which is relatively soft, and prone to galling with itself at stresses on the order of or greater than 14 MPa. This material has a relatively low Young's Modulus or stiffness of 186 GPa at a temperature of 149° C. It is well known that 316 type stainless steel is generally corrosion resistant in liquid sulfur environments, including environments of H₂S and low pH. As advantageous as the corrosion resistance of stainless steel 316 is to liquid sulfur environments, the relative softness of the material does not lend itself to any appreciable reduction in mass.

The shaft of the original prior art design is typically a long cantilever supported by two sets of roller bearings. However, the placement of the bearings combined with the length and mass of the shaft lends to torsional vibration upon rotation, because the dynamic coefficient of friction is less than the static value, facilitating the decrease in frictional force at the bearings supporting the shaft as the shaft begins to rotate. (Torsional vibration is angular vibration of an object—commonly a shaft along its axis of rotation. Because no material can be infinitely stiff, alternating torques applied at some distance on a shaft can cause twisting vibration about the axis of rotation.)

Shaft vibration imposes an additional load on the bearings and coupling components. Moreover, excessive vibration increases bearing noise and drastically shortens the life of a bearing. The combination and location of the two sets of roller bearings in the prior art design generates unwanted shaft displacement.

It was previously determined that roller bearings should be located by a shaft shoulder or step. Alternatively, a roller bearing may be attached to a shaft utilizing an expanding tapered sleeve. In the latter embodiment, the shaft diameter is slightly larger, but not enough to mitigate the current issues with deflection. The major draw-back of an adapter sleeve on a plain shaft is the assembly operation, insomuch as additional components are required to assist in locating each bearing on the shaft at the same exact location as the bearing-housing is holding the outer part of the roller-bearing. This process requires in-situ adjustments, and if not properly implemented can lead to bearing failure.

In order to accommodate the presence and location of two sets of roller bearings in the prior art design, the shaft needed to be turned-down from a nominal 89 mm diameter bar to a diameter of less than approximately 75 mm. This reduction in diameter resulted in a reduction in material, which made the shaft more prone to flex and displacement.

Thus, the roller bearings became a driving force that ultimately limited the shaft's practical maximum diameter.

For a shaft that extends approximately 1354 mm distant from the nearest roller bearing to bottom impeller's main shaft nut, the tip deflection (displacement) is approximately 7 mm with oscillating force amplitude of approximately 2438 N (548 lb) from the rotor including impellers. The exact value is a function of roller bearing clearances and the separation distance between the roller bearings, which for exemplary purposes need not be included. The shaft material's safety factor is approximately 1.2.

This approximate 7 mm deflection was greater than the new design's available impeller tip to casing radial clearance of approximately 0.5 mm to a maximum of approximately 1.0 mm at replacement. A 7 mm deflection would cause the impeller's tips to interfere with the casing. For radial tip clearance greater than approximately 1.0 mm, the fluid back-flow leakage between the impeller tip and casing can become excessive, reduction in pumping flow rate or insufficient pressure may develop, or the pump may cavitate, which may increase the fluctuating load on the main shaft. These events may lead to catastrophic failure.

The actual practical upper limit for maximum wear when pumping sulfur is approximately 1.5 mm, but the value of 1 mm is suitable for maximum practical wear guidelines for a new design, considering that sulfur's viscosity is more similar to light turbine oil than water.

Thus, the problems cited above require innovation of a new bearing design to mitigate the vibration and deflection issues confronting the prior art.

In the present design, one set of roller bearings was removed and two fully immersed bearings were introduced.

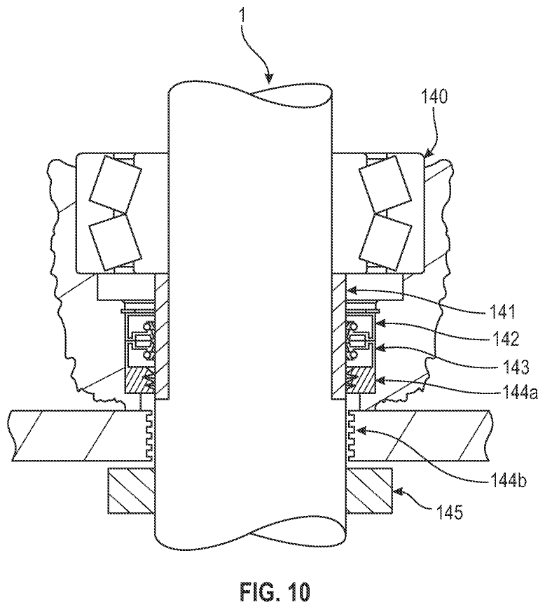

A toroidal roller bearing was deleted to remove over constraining the roller bearings in the radial direction. In this manner, the top of the main shaft is supported with a single roller bearing, supporting the main shaft in both the axial and radial directions, which could be the same style of roller bearing as presently designed, or could be deep-groove style roller bearing. FIG. 10 depicts a partial exploded view of a single roller bearing 140 centered about the shaft. A rotary seal sleeve 141 is located about the shaft proximate roller bearing 140. A lubricant seal 142 and sulfur lip seal 143 are adjacent the rotary seal sleeve 141. Hydrodynamic labyrinth seals 144a,b are utilized below seals 142 and 143. Prior to traversing down the shaft to the impellers, a shaft slinger 145 is employed. The shaft slinger 145 is clamped around the main rotating shaft 1.

Unlike some roller bearings, film lubricated journal bearings that are not fully immersed are not self-aligning. To simplify alignment of the roller bearing with the immersed bearing or bearings the casing, rotor, and drive were made as one bolt-in assembly of suitable tolerance parts for ease of assembly, alignment, and maintenance.

### Fully Immersed Bearings

Two bearings were introduced down the shaft, and at least one is fully immersed in the liquid sulfur that forms the lubricant.

A straight pipe casing configuration was utilized, however due to the introduction and placement of the two bearings down the shaft, the impeller's overall diameter was able to be increased from a nominal 6-inch to a nominal 8-inch pipe.

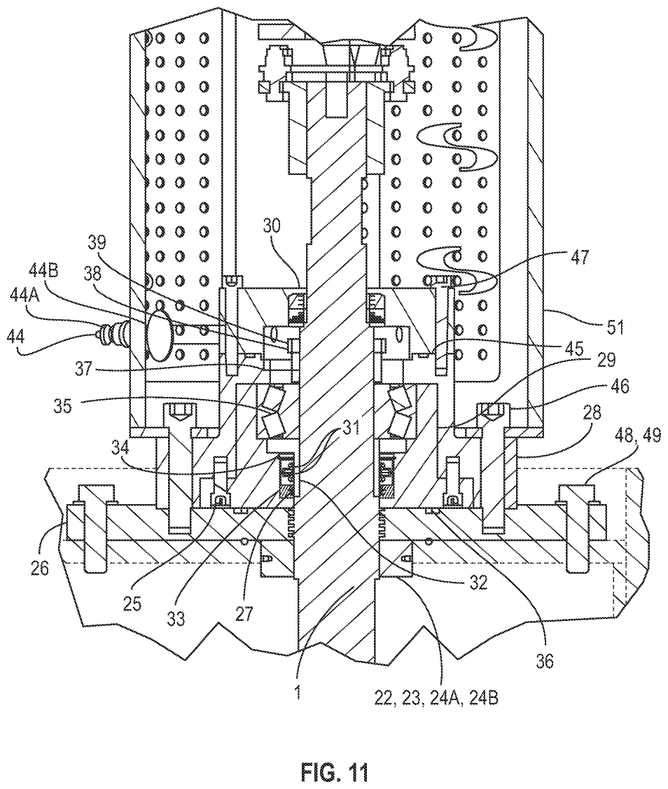

FIG. 11 depicts a cross-sectional, partial view of the upper impeller design. One set of roller bearings 35 is shown. A second one, generally available in prior art designs, and which would have been located proximate the first, has been removed. This removal facilitated placement of two bearings, one of which is fully immersed or at least partially immersed, further down the shaft 1 in order to address the vibrational displacement.

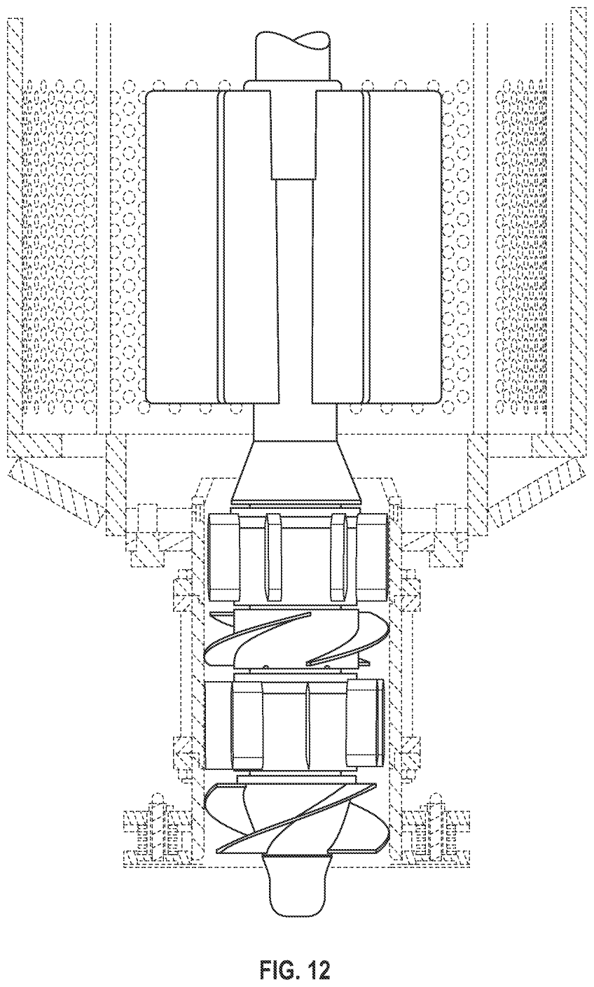

The placement of the immersion bearings 50, 52 further down shaft 1 is depicted in FIG. 12. This is well below the radial flow impeller (where roller bearings 35 are situated above). The placement of immersion bearings 50, 52 allows for the increase in the stators' and impellers' hubs to a nominal 5-inch diameter, which in turn increases the diameter and the sliding velocity of the bearing, as the velocity would otherwise be marginal for full film (liquid sulfur) lubrication. By increasing the bearing diameter, the tangential speed is correspondingly increased, yielding a sliding or tangential velocity of approximately 3.75 m/s with an immersed bearing inner diameter of approximately 100 mm at 750 rpm.

At 750 rpm the minimum film thickness becomes approximately 0.044 mm, 0.047 mm and 0.050 mm at sulfur temperatures of 154° C., 138° C., and 121° C., respectively. At 500 rpm the minimum film thickness decreases to 0.040 mm (sulfur temperature 138° C.), with the rotor load re-distributed over the one roller bearing and two immersed two bearings each with a length of approximately 100 mm, and each immersed bearing at first not employing axial grooves.

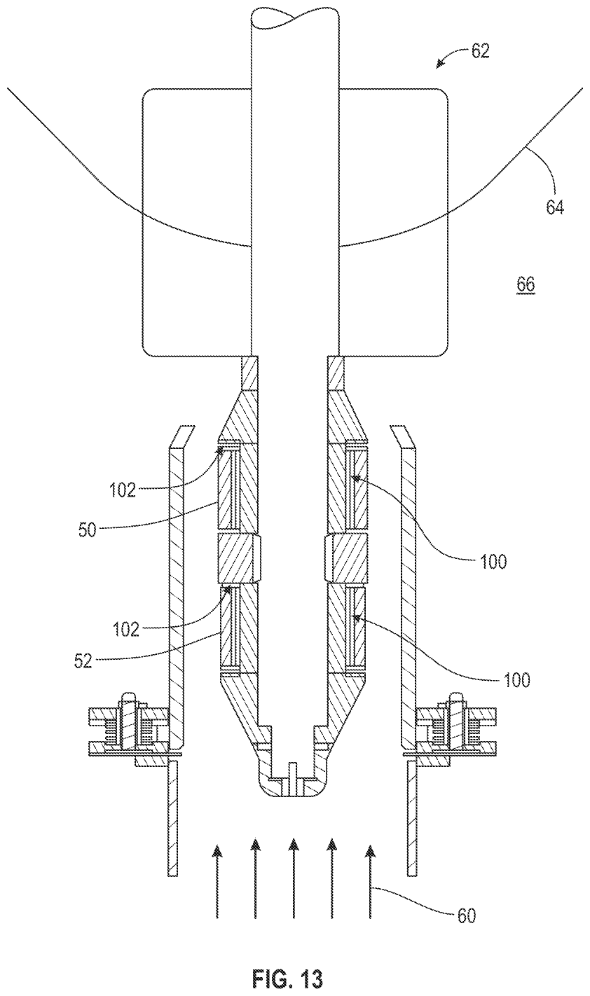

FIG. 13 depicts a cross-sectional schematic of the impeller/bearing design with bearings 50, 52 placed about the impeller shaft, and the directional fluid flow 60 of liquid sulfur through each immersed bearing. The central vortex air core 62 is also depicted, having vortex line 64, as it relates directly to the degassing function. Air is drawn in from the top, and its depth is controlled by rotor speed, and the diameter and depth of the upper radial flow or third-stage impeller. It has been demonstrated empirically that the vortex depth should be limited to a higher elevation than the topmost bearing, or else air may “flood” the bearing. A liquid sulfur region 66 is formed just below the vortex line 64.

There is access to the reactor's core for a high-temperature borescope to see the liquid surface of the vortex core during operation. In the current state of the art, the actual liquid-gas interference inside an actual reactor core is not observed, whilst in-service with the gas or air intake piping connected.

In the event air floods the bearing, the bearing mode would change from full-film lubrication to mixed-film lubrication, or boundary lubrication (direct rubbing of parts). It is possible that if the load amplitude is light, then the bottom bearing may support the bottom of the rotor in full-film lubrication while the upper sulfur bearing is flooded with air.

As an alternative to the fluid flow arrangement through the bearings, the fluid direction through the bottom bearing may be opposite the direction shown in FIG. 13.

Adding axial grooves 100 to each bushing of the immersion bearing was found to decrease film thickness by approximately 50%, leaving a practical minimum film thickness of approximately 0.020-0.025 mm. The pumping rate of axially distributed grooves at 750 rpm was on the order of 30,000 mm³/s, which was more than a bearing's required flow of approximately 17,000 mm³/s. It has been shown that fewer grooves may be used without overheating the bearing material or lubricating fluid, or if the load may be higher, or if the speed lower, or if manufacturing tolerances are less tightly controlled to decrease manufacturing cost.

Traditional vertical sulfur pump bearings include a spiral groove, and they are typically made from gray cast iron. A spiral groove would tend to decrease the load carrying ability of the film lubricated bearing or decrease the life, particularly as speed is decreased. It is not impermissible for spiral grooves to be employed in the present design; however, there may be some degradation in the bearing's life as a result. For the degasser of the present invention, a spiral groove is not required, as the fluid is pumped in and out of the bearing due in part to: a) the radial oscillation of the sleeve relative to the bush; b) the Venturi effect of the main flow; and c) the radial effect of rotating parts. The gray cast iron will readily corrode in low pH fluids; however, is still in frequent use in common use in vertical sulfur pumps.

The maximum amplitude movement during continuous operation of a journal bearing should be less than approximately 50% of the minimum film thickness and less than approximately 90% of the film thickness to provide full-film lubrication. Solid particles in the fluid should be smaller than the minimum film thickness. The bearing should not be used for pumping sand or slurries; however, the bearing may be used for pumping fluids including small dilute solids.

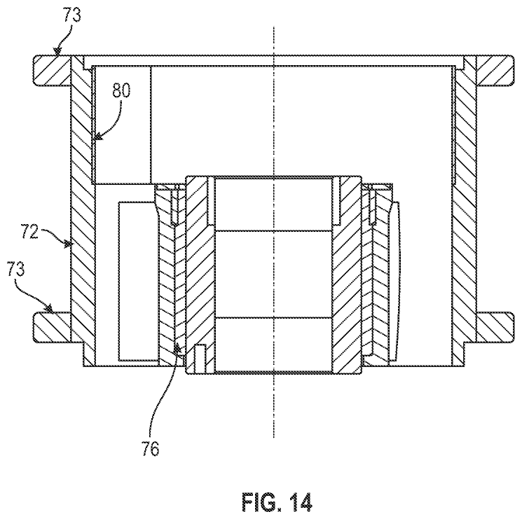

FIG. 14 depicts a cross-sectional view of an immersion (sleeve-type) bearing, showing the shaft surrounded by a sleeve and sulfur bearing bush or bushing 76.

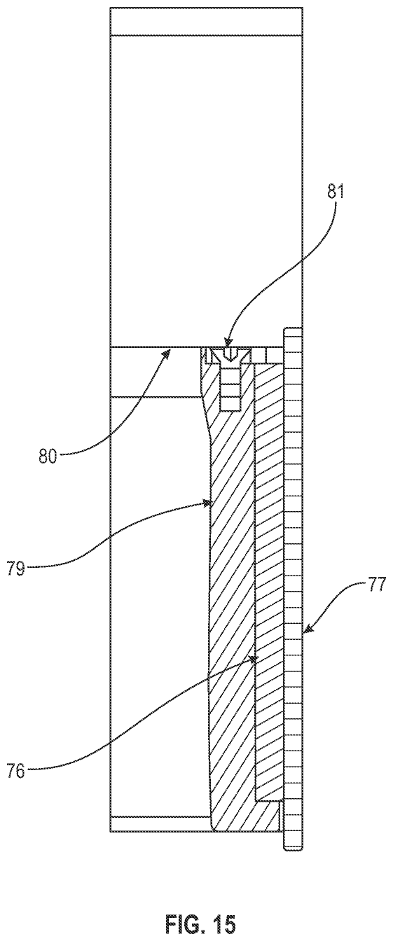

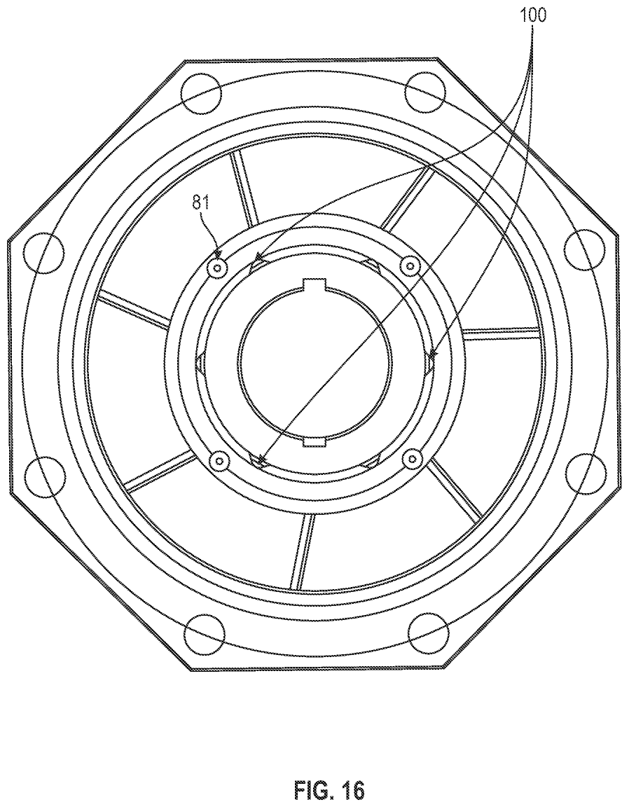

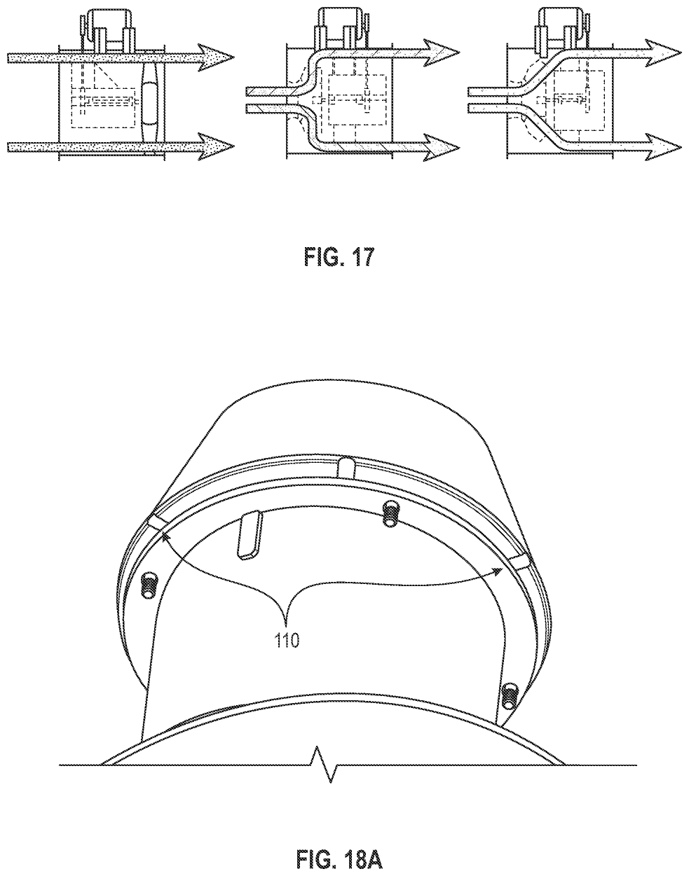

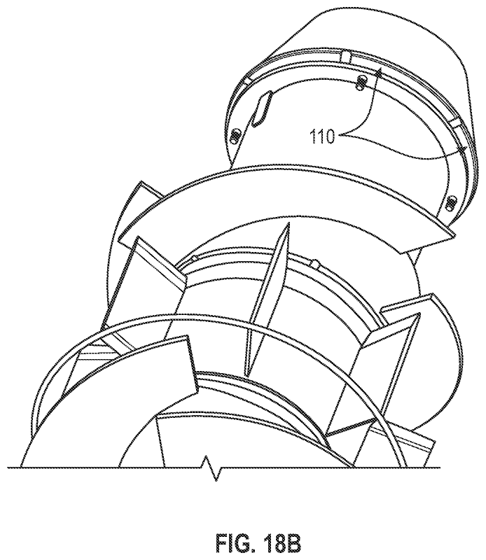

FIG. 15 depicts a partial cross-sectional view of an immersion bearing of FIG. 14 showing the proximate relationship between sulfur bearing bush or bushing 76, sulfur bearing sleeve 77, outer round bar 74, and wearing ring 79.

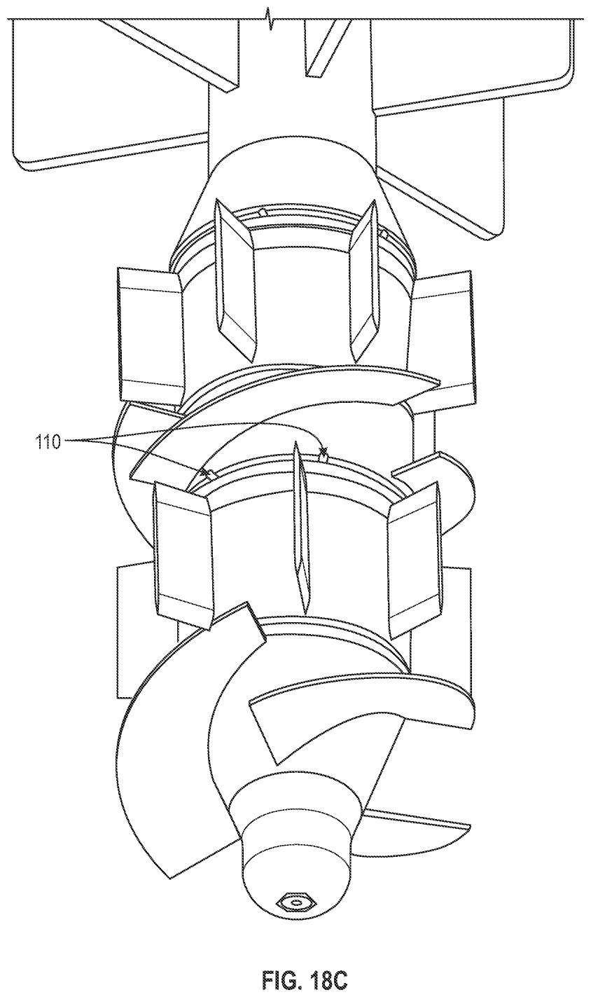

FIG. 16 is a cross-sectional view of the impeller design looking vertically down the shaft axial center. Axial grooves 100 can be seen formed in the bearing bush.

The new bearing is effectively pressure fed. The hydraulic head change or pressure drop across the bearing is greater than zero, and equivalent to greater than approximately 4 mm to 6 mm of liquid sulfur head. The pressure differential supplies liquid sulfur to the bearing. The flow is generally upwards, in the same direction as the bouncy force on the bubbles, to avoid bubbles accumulating inside the bearings. The flow is depicted in FIG. 13.

Two external effects are used to transport fluid into and out of a bearing. The first is the Venturi Effect. The cross-sectional area of the main flow passage adjacent to the bearing is decreased at the outlet or top, which in turn increases the velocity and decreases the static pressure in order to create a pressure decrease from bearing inlet to outlet. In this manner, the inlet pressure is effectively greater than outlet pressure. When bearing includes a gas void, the gas void is removed using the gas void buoyancy and the fluid pressure difference to draw or push the void out. Fluid is effectively drawn into and out of the bearing.

The second transport may be via radial groove, blade, vane 102 or rotating surface features. Radial grooves are cut into the exposed underside face of the rotating outlet to propel fluid, including bubbles, away from the bearing's outlet. Alternatively, grooves, blades, or vanes could be added to the rotating face to similarly propel fluid away from the bearing's outlet, so that fluid is pulled into the bearing at the inlet. The radial features are within the bearing's fluid outlet path and transfer energy to the fluid and impart a radial component to the velocity of the fluid as the fluid exits the bearing. Fluid is effectively pulled into and out of the bearing. The radial grooves 102 impart radial velocity to the fluid.

The radial groves or blades are rotating surface features, in a similar manner as the radial flow vanes of a radial flow (centrifugal) pump. Their rotation pulls and spins the liquid in a radially outwards direction. The radially moving fluid is pushed and received into the main flow of the degasser.

In one embodiment, six radial grooves are used, but this number can easily increase to ten or fifty grooves. The depth of the grooves may also be changed. Conversely, blades may be used instead of groves. The radial features push fluid outwards, away from the bearing exit, and using the same mechanism as a radial flow pump, the features pull (draw) fluid along the axis of the bearing, pulling fluid axially through the bearing.

The grooves or vanes may be straight radial features, or they may be forwards or backward curved radial features relative to the direction of rotation. An electronic bearing wear monitoring system may be fitted, for example a system using vibration, wear (distance) or film thickness measurement during operation.

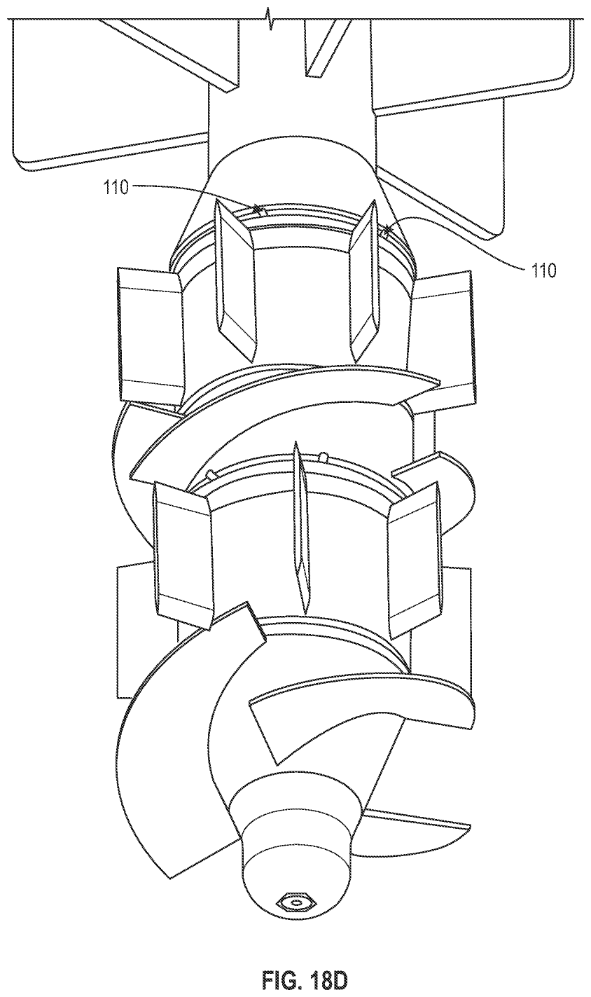

FIG. 17 depicts the flow of the liquid sulfur through axial grooves, radial grooves, or a combination of both.

FIGS. 18A-D depict the radial grooves 110 proximate the main shaft at various locations.

Once the fluid is in the bearing, the fluid is distributed by the grooves that are in a generally axial pattern. The number of grooves is minimized to maximize film thickness; however, in practice two, three, or six grooves are typical depending on required maximum shaft speed, to avoid fluid resonances at the higher speeds or to increase the bearing's pumping action to carrying away heat. The grooves may also transport wear particles or foreign particles away from a rubbing surface to reduce the wear rate.

The bearing's grooves help collect the sheared (heated) liquid sulfur that thickens, if its temperature is excessively elevated above sulfurs ˜160° C. polymerization temperature—if a bearing is overloaded or rubbing at a spot then the heat may be carried away or cooled by sulfur flowing in the bearing's grooves.

The sleeve on the main-shaft and the bearing bush in the stator hub, and the impeller-hubs on the main-shaft or such assemblies of parts that include a clearance gap where liquid sulfur may be present in the annulus are available to function as squeeze-film dampers, if needed. Fluid in the annulus between the parts that are rotationally stationary relative to one another is intended to damp rotodynamic motions of the shaft, so that the damper may perform whirl motions without rotation. The squeeze-film damping method is intended to operate at relatively low squeeze film Reynolds numbers of much less than 1.

Consideration in the designs is given to chambers that may be filled with sulfur in the liquid phase, which should either be self-draining or include volume to allow for the potential solid's expansion, or directly connect with a passageway to relieve stress or drain. If liquid sulfur is not drained from a chamber and if the liquid sulfur is freezes in the chamber, and if liquid sulfur continues to flow into the chamber and cause the chamber to be completely full of solid sulfur then the situation can require special care, cause damage, require repair or non-obvious extra expense to warmup or re-start. Unlike water that expands as it freezes, sulfur shrinks as it freezes. If a constrained chamber is full of sulfur in the solid phase and its contents is heated to melting point, then the sulfur will expand that should be considered in the chamber's allowable stresses, strains, and design life.

### Bearing Material

Empirical evidence has shown that some carbon-graphite composites may fail relatively quickly, or may be non-ideal in some sulfur environments. For example, carbon-graphite may be porous, may fail in sulfur service, or tends to blow-apart in sulfur service. The voids may fill with liquid sulfur that freezes in place and expands on remelting—the rapid expansion exploding the material. In that light, carbon-graphite bearings should only be used if they are filled with a suitable polymer. Normally carbon-graphite bearings are porous, so sulfur would rupture the bearing the first time a degasser is restarted following a stop.

Carbon bushes and brushes are sometimes used in pumps and often used in wind-turbines, but carbon bush material is generally a soft material, not ideal if there are abrasive particles in the fluid. It typical needs to be a relatively thick bush, which is not ideal when trying to maximize the bush diameter without blocking the main flow-path in an axial flow pump.

Teflon or PTFE bearings have also been tested for approximately 3-months service, and it has been shown that PTFE is less than optimal bearing material in sulfur service, when needing to maintain 0.5 to 1.1 mm tip to casing clearance for greater than 10,000 hours or 1-year service.

The preferred material is an austenitic, nitrogen strengthened steel that is stronger to grade 316 and 317 stainless steels, such as UNS S21800 alloy 218, for use in both the bearing bush and the sleeve. This material minimizes thermal differences during warm-up, as well as minimizing the changes to the clearances between the sleeve and bush (during warm-up). Other stainless steels were considered, in some instances providing less corrosion resistance or more complex thermal expansions to balance, e.g., utilizing 2205 stainless steel, the shaft would not expand as much as the 316 stainless steel casing including the 316 wear-ring. A 420-type stainless steel may be utilized for the sleeve with Ni-Resist type 2 bushing material.

Ni-Resist (austenitic cast iron) may be considered for the bearing bush (however is not as corrosion resistant as austenitic, nitrogen strengthened steel; however, it generally has better corrosion resistance than gray cast iron in low pH fluid. Its wear rate or galling resistance is not as an efficient type stainless steel for this use. If Ni-Resist is used then its thermal expansion must be designed in or matched with the other parts of the rotor and casing to maintain clearances at service temperature. Its thermal expansion is adjustable by its nickel content, e.g., type 2 is near aluminum, approximately 19 m/m/° C.×10-6 or a slightly greater than 16 m/m/° C.×10-6 for 316 SS and greater than 14 m/m/° C.×10-6 for 2205, and 12 m/m/° C.×10-6 for carbon steels.

### Nose-Cone or Main Shaft Nut Material

The main shaft nut and commonly adjusted screws and bolt material is also specially selected, so that components will not gall (or are galling resistant), and are corrosion resistance with similar thermal expansion. The nose-cone nut is locked on using a locking washer for ease of rotor and casing part replacements. A Loctite compound is used as an anti-seize or lubricant (is not a locking compound) to help avoid SS 316 threads being seized during assembly and servicing. The non-lubricated galling resistance of the annealed austenitic, nitrogen strengthened steel material is 262 MPa, which is significantly greater than 14 MPa for 316 type stainless steel. In at least one embodiment, the main shaft nut and nose cone may be formed from nitrogen strengthened steel that is stronger to grade 316 and 317 stainless steels, such as UNS S21800 alloy 218.

Care is taken to ensure the materials selected are thermal balanced. Coefficients of Expansions were compared, analyzing change of dimensions, strength at ambient and operating temperature, wear, and corrosion resistance.

The thermal expansion values of the materials were balanced axially, e.g., to ensure the main shaft's nut remains tight as the rotor warms without need for a preload spring. Alternatively, one or more axial preload springs may be added to enable different rotor and/or bearing material, temperature, and dimensional combinations. The thermal expansion values of the rotor and casing parts were balanced radially to ensure the sleeve remains in tolerance, and to ensure the bushing remains snug in the yoke or bushing housing that is the stator.

Other materials may be utilized including, but not limited to some plastics that do not dissolve in liquid sulfur. The upper temperature limit of the plastic material is important. The bearing material should be as thin as possible, and it should be on contact with as much metal as possible to use the metal to transfer the heat away. The plastic bearing material may be at a temperature of approximately 210° C., if the sulfur film is cooled or removed. A hardened shaft sleeve with a plastic bush material may be utilized to protect the shaft. The finish of the sleeve must be as smooth as practical, should be a ground finish and not a machined finish.

Rotating parts, such as impellers, are generally keyed with two or more keys to uniformly distribute voids circumferentially around the main shaft for improved static and dynamic balance, or to reduce need for static or dynamic balancing with high speeds or low manufacturing tolerances. Single keys may be used as an option for attachment. Splines may be used as an option for attachment.

The manufacturing fits and finishes are chosen to suit requirements of rotor, immersed bearings, impellers, and seals.

The housing may be jacketed or heated externally to avoid need for draining when pump is stopped as an option.

While the present invention has been particularly described, in conjunction with a specific preferred embodiment, it is evident that many alternatives, modifications and variations will be apparent to those skilled in the art in light of the foregoing description. It is therefore contemplated that appended claims will embrace any such alternatives, modifications and variations as falling within the true scope and spirit of the present invention.

Thus, having described the invention, what is claimed is:

1. A degassing system for removing hydrogen sulfide (H₂S) and hydrogen polysulfides (H₂Sₓ) from liquid sulfur, comprising:
at least two rotodynamic degassing pumping units, each having a top end and a bottom end, and each equipped to receive incoming liquid sulfur through at least one inlet;
each of said at least two rotodynamic degassing pumping units having a bladed impeller rotatably operable by a motor;
a first of said at least two rotodynamic degassing pumping units receiving said incoming liquid sulfur from an outside source;
said at least two of said rotodynamic degassing pumping units configured in series and having a resulting pumping action therebetween, establishing liquid transfer from one of said rotodynamic degassing pumping units to a next degassing unit in series via negative pressure or substantial vacuum, such that liquid is drawn from one rotodynamic degassing pumping unit to another.

2. The degassing system of claim 1 wherein said motor is configured directly to drive a shaft of each of said at least two rotodynamic degassing pumping units.

3. The degassing system of claim 1 wherein said motor includes a variable frequency drive to adjust speed of said bladed impeller, which controls recirculation inside each of said at least two rotodynamic degassing pumping units.

4. The degassing system of claim 3 wherein a dedicated variable frequency drive is provided for each motor of said at least two rotodynamic degassing pumping units.

5. The degassing system of claim 1 wherein each of said at least two rotodynamic degassing pumping units includes a draft-tube communicating with ducting for supplying a stripping gas to separate the hydrogen sulfide (H₂S) and hydrogen polysulfides (H₂Sₓ) from the liquid.

6. The degassing system of claim 5 wherein said draft-tube is centrally located in each of said at least two rotodynamic degassing pumping units, and extends below a surface of said liquid sulfur.

7. The degassing system of claim 5 wherein said stripper gas is fed through said draft-tube towards said bladed impeller, wherein said stripper gas includes nitrogen gas, an inert gas, a low oxygen-containing inert gas, or a non-inert gas containing oxygen, sulfur dioxide, or hydrogen sulfide.

8. The degassing system of claim 1 wherein said resulting pumping action is achieved by operation of said bladed impellers.

9. The degassing system of claim 5 wherein said bladed impeller is surrounded by said draft-tube having a plurality of apertures or openings.

10. The degassing system of claim 9 wherein said bladed impeller is rotatable at a speed capable of drawing said liquid sulfur into an interior of said draft-tube.

11. The degassing system of claim 1 wherein said liquid sulfur includes hydrogen sulfide gas and a degassing catalyst.

12. The degassing system of claim 11 wherein a second fluid in the gaseous phase is pumped or drawn under pressure or vacuum into the liquid sulfur, effecting a chemical reaction to modify the surface tension of the liquid sulfur.

13. The degassing system of claim 1 wherein the liquid level within each of said at least two rotodynamic degassing units is approximately at equal height to one another during a degassing operation. allowing for each of said rotodynamic degassing units to be at approximately the same height with respect to one another.

14. The degassing system of claim 1 wherein said bladed impeller for each of said at least two rotodynamic degassing pumping units has a vertical axis and provides mechanical agitation upon rotation, and includes: a plurality of blades situated about a rotational shaft along the vertical axis, said rotational shaft in mechanical communication with a motor.

15. The degassing system of claim 14 wherein said bladed impeller forms a radial flow, axial flow, and mixed (axial and radial) flow impeller section.

16. The degassing system of claim 15 including a stator between said mixed impeller section and said axial impeller section.

17. The degassing system of claim 16 including a nozzle for each of said at least two rotodynamic degassing pumping units directing said liquid sulfur upwards towards said top end to entrain adjacent fluid and shear said fluid.

18. The degassing system of claim 2 including an axial floating bearing on said shaft.

19. The degassing system of claim 18 including a hydrodynamic labyrinth seal to protect a lower rotary lip sulfur seal and a main-shaft slinger on said shaft.

20. The degassing system of claim 19 wherein said main-shaft slinger is clamped or slidably attached to said shaft, around an outside surface of said shaft, rotating with said shaft, and preventing direct impact of a liquid jet on said labyrinth seal.

21. The degassing system of claim 20 wherein if said at least two rotodynamic degassing pumping units continually operate with a liquid level that continually immerses an area about the seals, then said shaft slinger and said labyrinth seal are replaceable with a steam-filled bellows type seal.

22. The degassing system of claim 20 including a single roller bearing at an end of said shaft near said motor.

23. The degassing system of claim 1 including interconnecting piping between each of said at least two rotodynamic degassing pumping units, wherein nominal internal diameter of said interconnecting piping is in a range of 2 to 8 inches.

24. The degassing system of claim 22 wherein said floating bearing comprises UNS S21800 alloy 218.

25. The degassing system of claim 11 wherein said catalyst forms a solid monolith immersed in a fluid flow path, or is formed on surfaces of veins of a stator, or is formed within a tailpipe outlet nozzle, or on a radial flow distributor of said draft-tube, such that said fluid is pushed over an outside surface of said solid monolith catalyst.

26. A rotary impeller having a vertical axis and providing mechanical agitation to a rotodynamic degassing pumping unit, said rotary impeller comprising:
a plurality of blades situated about a rotational shaft along the vertical axis, said rotational shaft in mechanical communication with a motor, said plurality of blades including:
a mixed flow impeller section having blades in mechanical communication with said rotational shaft and responsive to said motor, said mixed flow impeller section blades formed having a predetermined first pitch and/or predetermined first angle to provide aeration to a fluid and transfer said fluid upwards, and to facilitate a pumping action for said degassing unit.

27. The rotary impeller of claim 26 including an axial flow impeller section having blades formed having a predetermined second pitch and/or predetermined second angle, said axial flow impeller section blades forming a circular control volume defined by an outer diameter of said axial flow impeller section blades, said axial flow impeller section adjacent said mixed flow impeller section.

28. The rotary impeller of claim 27 including a radial flow impeller section having blades in mechanical communication with said rotational shaft and responsive to said motor, and formed having a predetermined third pitch and/or predetermined third angle, such that said radial flow impeller section blades rotate at a predetermined speed to optimize fine, granular bubbles, and entrain said bubbles in said fluid during rotation, said radial flow impeller section blades configured to direct said fluid radially outwards from said rotary impeller.

29. The rotary impeller of claim 28 wherein said radial flow impeller section blades direct fluid outwards toward a draft-tube encompassing at least a portion of said plurality of blades.

30. The rotary impeller of claim 26, wherein said mixed flow impeller section blades formed at said predetermined first pitch and/or angle establish said pumping action upon rotation, such that fluid is drawn from said rotodynamic degassing pumping unit to an input of a second rotodynamic degassing pumping unit connected in series.

31. The rotary impeller of claim 28, wherein said mixed flow impeller section blades are formed at said predetermined first pitch and/or angle to draw fluid, including bubbles, air, or entrained gas, upwards towards said radial flow section.

32. The rotary impeller of claim 26 including guide vanes mounted proximate said mixed flow section, utilized to reduce power consumption.

33. The rotary impeller of claim 27 wherein said mixed flow impeller section and said axial flow impeller section are separated by a gap.

34. The rotary impeller of claim 33 wherein a stator is attached to said rotary impeller at said gap.

35. The rotary impeller of claim 28 wherein said rotary impeller is rotatable about the vertical axis at a speed of greater than 300 rpm, capable of drawing liquid sulfur into the interior of said draft-tube, and distributing a gas stream as bubbles, forming a gas-liquid mixture.

36. The rotary impeller of claim 26 wherein said motor includes a variable frequency drive with the capability of adjusting the speed of said rotary impeller.

37. The rotary impeller of claim 36 wherein said variable frequency drive motor provides for gradual start-up of said rotary impeller.

38. The rotary impeller of claim 26 including a nose cone or main shaft nut, and a tail cone.

39. The rotary impeller of claim 28 wherein said mixed flow impeller section and said axial flow impeller section draw fluid that is substantially liquid, and said radial flow impeller section predominantly draws air from a top portion of said rotary impeller.

40. The rotary impeller of claim 26 wherein said plurality of blades are totally immersed in said fluid.

41. The rotary impeller of claim 37 wherein said rotor speed is adjusted down to approximately 300 rpm to 1000 rpm upon start-up.

42. The rotary impeller of claim 28 wherein at least a portion of said plurality of blades are flat-plate blades.

43. The rotary impeller of claim 28 wherein said at least a portion of said plurality of blades have a cross section that is curved or profiled to increase suction pressure and flow upon rotation.

44. The rotary impeller of claim 28 wherein at least one impeller section operates in a partial cavitating mode.

45. The rotary impeller of claim 28 wherein said radial flow impeller section includes a plurality of blades in a casing draft-tube at a submerged location in said fluid, surrounded circumferentially by a radial distributor.

46. The rotary impeller of claim 45 wherein said radial distributor is a diffuser including a plurality of apertures.

47. The rotary impeller of claim 28 wherein said radial flow impeller section develops a vortex upon rotation that extends to within said radial impeller section or below.

48. The rotary impeller of claim 28 wherein sparge or stripping gas is introduced proximate to and above said radial flow impeller section.

49. The rotary impeller of claim 27 wherein said mixed flow impeller section is below said axial flow impeller section, and said mixed flow impeller section facilitates pumping action within said rotodynamic degassing pumping unit.

50. The rotary impeller of claim 28 wherein said radial flow impeller section is above said axial flow impeller section.

51. A rotodynamic degassing pumping unit for removing hydrogen sulfide (H₂S) and hydrogen polysulfides (H₂Sₓ) from liquid sulfur, comprising:
a bladed impeller rotatably operable by a motor, said bladed impeller including a mixed flow impeller section having blades in mechanical communication with a rotational shaft and responsive to said motor, said mixed flow impeller section blades formed having a predetermined first pitch and/or predetermined first angle to provide aeration to a fluid and transfer said fluid upwards, and to facilitate a pumping action for said degassing unit.

52. The rotodynamic degassing pumping unit of claim 51 including an axial flow impeller section having blades formed having a predetermined second pitch and/or predetermined second angle, said axial flow impeller section blades forming a circular control volume defined by an outer diameter of said axial flow impeller section blades, said axial flow impeller section adjacent said mixed flow impeller section.

53. The rotodynamic degassing pumping unit of claim 52 including a radial flow impeller section having blades in mechanical communication with said rotational shaft and responsive to said motor, and formed having a predetermined third pitch and/or predetermined third angle, such that said radial flow impeller section blades rotate at a predetermined speed to optimize fine, granular bubbles, and entrain said bubbles in said fluid during rotation, said radial flow impeller section blades configured to direct said fluid radially outwards from said bladed impeller.

54. The rotodynamic degassing pumping unit of claim 53 including an overflow weir having a corrugated type cross-section with segments split longitudinally and welded lengthwise.

55. The rotodynamic degassing pumping unit of claim 54 wherein said cross-section presents a “wavy” or sinusoidal cross-sectional shape, or trapezoidal or triangular shape (extending radially inwards), to increase said overflow weir's length.

56. A method for removing hydrogen sulfide and hydrogen polysulfides from liquid sulfur comprising:
providing a rotodynamic degassing pumping unit having a rotary impeller having a plurality of blades at a submerged location in said liquid sulfur about a rotational shaft, including:
a mixed flow impeller section having blades in mechanical communication with said rotational shaft and responsive to a motor, said mixed flow impeller section providing aeration to a fluid and transferring said fluid upwards, facilitating a pumping action for said rotodynamic degassing pumping unit;
providing a draft-tube surrounding said rotary impeller, said draft-tube having a plurality of apertures;
feeding a stripping gas for hydrogen sulfide to said submerged location;
providing a catalyst for conversion of hydrogen polysulfides to hydrogen sulfide;
rotating said rotary impeller about a vertically mounted shaft at a speed sufficient to draw liquid sulfur into the interior of the draft-tube and distribute said stripping gas, forming a gas-liquid mixture;
flowing said gas-liquid mixture through said draft-tube plurality of apertures; and
removing said stripping gas from said liquid sulfur.

57. The method of claim 56 including forming a circular control volume by rotating an axial flow impeller section having blades, such that said blades define said circular control volume by an outer diameter of said axial flow impeller section blades, said axial flow impeller section adjacent said mixed flow impeller section.

58. The method of claim 57 including optimizing fine granular bubbles in said liquid sulfur, and entraining said bubbles during rotation by rotating a radial flow impeller section having blades in mechanical communication with said rotational shaft and responsive to said motor, said radial flow impeller section blades configured to direct said fluid radially outwards from said rotary impeller.
